(19) United States
(12) Patent Application Publication
(10) Pub. No.: US 2005/0186305 A1
(43) Pub. Date: Aug. 25, 2005

(54) Protected dry composites

(75) Inventors: Moshe Rosenberg, Davis, CA (US); Edward J. DePeters, Davis, CA (US)

Correspondence Address: QUINE INTELLECTUAL PROPERTY LAW GROUP, P.C., P O BOX 458, ALAMEDA, CA, 94501, US

(73) Assignee: The Regents of the University of California, a California corporation, Oakland, CA (US)

(21) Appl. No.: 11/046,543

(22) Filed: Jan. 27, 2005

Related U.S. Application Data
(60) Provisional application No. 60/540,854, filed on Jan. 30, 2004.
(60) Provisional application No. 60/632,124, filed on Nov. 30, 2004.

(51) Int. Cl. A01K 1/00

(52) U.S. Cl. 426/2

(57) ABSTRACT

This invention provides dry composites to, e.g., efficiently deliver unmodified amino acids, lipids, and/or feed supplements through the upper digestive tract of an animal. The invention also provides methods and systems to make and use protected dry composites.

### CROSS-REFERENCE TO RELATED APPLICATIONS

This application claims priority to and benefit of prior U.S. Provisional application No. 60/632,124, “Protected Dry Composites”, by Moshe Rosenberg, et al., filed Nov. 30, 2004, and U.S. Provisional Application No. 60/540,854, “Rumen Protected Dry Composites”, by Moshe Rosenberg, et al., filed Jan. 30, 2004. The full disclosures of each of these prior applications are incorporated herein by reference.

### FIELD OF THE INVENTION

This invention is in the field of household pet and livestock feed supplements. The present invention relates to, e.g., dried composite gels for protecting lipids, proteins, and/or supplemental constituents during passage through an upper digestive tract of an animal, and methods to make and use such dry compositions. Dry composites of the invention can be, e.g., fed to cattle or other ruminants, whereby lipids, nutrients, and/or bioactive molecules can pass through the rumen without degradation, modification, or removal. The dry composites can be fed to non-ruminant animals to as a palatable feed to deliver supplements to the lower digestive tract. The dry composites can lower feed supplement costs and improve the health promoting quality and general nutritional of milk, resulting dairy products, animal tissue, and derived meat products.

### BACKGROUND OF THE INVENTION

A large part of the saturated fats consumed by humankind are in the form of meat and dairy products from ruminant animals. These saturated fats are known to be associated with an increased risk of diseases, such as cancer and heart disease. Lowering the percentage of saturated fats in ruminant food products could provide a substantial benefit to human health.

Ruminants, such as cattle, sheep, and goats, have a stomach consisting of four compartments, which allows them to digest forage high in fiber (e.g., cellulose). Cattle, for example, have a stomach with four compartments, the rumen, reticulum, omasum, and abomasum, through which feed passes before entering the small intestine. Microorganisms in the rumen have cellulase enzymes that can convert cellulose into volatile fatty acids, which a can be used as an energy source for the ruminant animal. This energy source is not available to the same extent in many other herbivores, such as horses and pigs.

Scientists have had some success in reducing the percentage of saturated fats in non-ruminant animals, such as pigs and chickens, by including large amounts of polyunsaturated fats in their feed (diet). This strategy does not work well in ruminants, however, because large amounts of fat, especially polyunsaturated fats, have a toxic effect on the rumen microorganisms, such as the microbes that produce cellulase. As a result, the animal obtains less energy from the diet as fiber digestion in the rumen is reduced. The reduction in energy obtained from the diet results in a decrease in productivity of the animal. There also can be a reduction in feed intake by the animal as a result of the negative effect of unsaturated fats on the rumen microorganisms (e.g., the animal loses its appetite). These events can contribute to reduced animal performance, for example decreased milk, meat and/or dairy production.

When polyunsaturated fats are added to cattle feed below the levels toxic to rumen microbes, the saturation of fats in their meat and milk and resulting dairy products is generally not reduced. This is because microbes of the rumen modify the fats provided in the diet in a process called biohydrogenation. When fats (lipids) enter the rumen, free fatty acids are released by hydrolysis. In biohydrogenation, the majority of the unsaturated fatty acids (e.g. fatty acids containing double bonds between some carbons) are hydrogenated to saturated fatty acids (e.g. fatty acids containing no double bonds between some carbons). Ultimately, the diet fat composition is not reflected in the fat composition of the meat and milk produced by ruminants. Biohydrogenation of polyunsaturated fats in the rumen reduces the polyunsaturated fatty acids available for fat synthesis in muscle/adipose tissue and in the mammary gland, so ruminant tend to have fats higher in saturated fatty acids and lower in unsaturated fatty acids. These more saturated fats ultimately appear in the meat and dairy products.

Strategies have been developed to feed cattle diets high in oils with fewer toxic effects and reduced biohydrogenation. For example, in U.S. Pat. No. 6,229,031, “Method for Manufacturing Rumen Bypass Feed Supplements” to Strohmaier, fats are saponified in the presence of calcium salts to prepare a less toxic high fatty acid feed composition that minimizes biohydrogenation in the rumen. The fatty acid calcium salts, however, are unappetizing to the animals, which may eat less, thus reducing their milk or meat production. Furthermore, the calcium salts of fatty acids are known to undergo dissociation in the rumen, significantly compromising the desired protection against modification or biohydrogenation. The functionality of calcium salts of fatty acids in the protecting the fatty acids in the rumen is limited.

Another way to introduce more unsaturated oils into ruminants with reduced toxic effects is described in U.S. Pat. No. 4,073,960, “Meat and Milk Products from Ruminants”, to Scott. Here, lipids are microencapsulated in a protein aldehyde reaction product. A formaldehyde or glutaraldehyde cross-linked protein coat on the lipid filled capsule is insoluble in rumen conditions of pH 5, or more. The capsules retain and protect the lipids until they are passed to the abomasum where the capsule is dissolved at a pH of 4 or less. The capsules do not appear to be toxic to rumen microbes or to adversely affect appetite when fed to cattle. This system of encapsulation allows polyunsaturated fats to pass through the rumen without biohydrogenation. The polyunsaturated fats are absorbed in the lower digestive tract for incorporation into the meat and dairy products of the animal. However, regulations in the United States, and many other countries, prohibit formaldehyde or glutaraldehyde treatment of feed for animals meant for human consumption. It has been reported that toxic substances, originating from the aldehydes-cross-linked formulations are carried over to milk and ultimately to consumers of the milk and dairy products prepared with this milk. Theses compounds have been indicated to be toxic to human. An additional problem with preparation of these microcapsules can be the prohibitive expensive for feed applications.

Another way to rumen protect unsaturated oils in protein capsules is by cross-linking the proteins with reducing sugars in the Maillard reaction, as described in U.S. Pat. No. 5,143,737, “Method to Produce Unsaturated Milk Fat and Meat From Ruminant Animals”, to Richardson. In Richardson, an aqueous colloidal dispersion of vegetable oil in a solution of protein and reducing sugar is freeze dried to yield a dry powder. The dry powder is then browned in an oven to produce dry rumen protective granules. The process can fail to promote other useful cross-linking chemistries, such as disulfide bonding. The process can be expensive due to the requirement of the reducing sugars, and extensive drying steps at high temperatures for a long period of time. The process involves freeze drying which is an expensive batch-type operation. In addition, dry baking at temperatures required for effective Maillard cross-linking rates can oxidize the unsaturated constituents of the oils, and significantly damage other supplements and nutrients in the composition. The products of such oxidation are also known to be toxic and pose risks to animal tissue and physiological activities.

Another way to protect lipids and supplemental constituents in transit through a rumen is in the form of a composite gel, as described in U.S. patent application Ser. No. 10/620,315, “Method and Compositions for Preparing and Delivering Rumen Protected Lipids, Other Nutrients and Medicaments”, by Rosenberg, et al. Rosenberg, in this case, emulsifies a lipid filler composition into a protein matrix suspension, and heats the colloidal dispersion to form a rumen protected composite gel.

Rumen microbes are also known to modify or remove many other feed supplements added by farmers, such as proteins, antibiotics, and vitamins. Feed supplements can be protected to some extent by using the fatty acid calcium salts or the formaldehyde cross-linked capsules described above, but the problems associated with administration of these strategies remain. In addition, the fatty acid or lipid carriers inherent in these technologies are not suitable carriers for certain desirable water soluble supplements.

Current methods of feeding supplements to non-ruminant animals also need improvement. Direct feeding of lipids to non-ruminants can be problematic due to unpalatability of the feed and gastric discomfort that can be caused. Benefits of direct feeding to non-ruminants can be reduced when they reduce consumption. Difficulties in feeding supplements and medicaments to animals are also well known problems, e.g., because of degradation in the stomach and rejection due to the unusual smell or flavor.

In view of the above, a need exists for non-toxic and efficient ways to protect polyunsaturated lipids and feed supplements from degradation, modification, or removal while passing through the rumen or stomach of animals. It can be desirable to provide light weight rumen protected supplements that are, e.g., stable in open containers. Benefits can be realized from technologies that enhance the palatability of supplements. The present invention provides these and other features that will be apparent upon review of the following.

### SUMMARY OF THE INVENTION

The present invention provides compositions, methods, and systems for protecting dry composites in passage through the upper digestive tract of an animal. Compositions include, e.g., filler particles embedded in a structural matrix resistant to degradation by conditions found in a rumen or stomach. Methods of preparing rumen protected dry composites include, e.g., preparing a composite gel and drying the gel to form a dry composite protected from degradation in the rumen and having a particle size of 150 μm or more, or from about 0.01 mm to about 10 mm. Methods of preparing dry composite can include, e.g., emulsification of a filler composition into a matrix suspension, spraying or phase suspending drops of the emulsion into a gelation media, heating the drops to form composite gel particles, and drying the gel into dry composite particles. Systems for preparing dry composites include integrated systems including a dispersion unit to prepare colloidal dispersions, heaters to convert the dispersions into gels, and dryers to remove water from the gels, thus forming protected dry composites.

A typical dry composite of the invention includes a structural matrix of, e.g., one or more cross-linked proteins and a matrix reinforcement component, and filler particles embedded in the structural matrix, so that dry composite substantially protects the filler particles against degradation, modification, or removal during passage through an upper digestive tract. The dry composites can rumen protect supplemental constituents, such as vitamins, proteins/amino acids, nutrients, polyunsaturated lipids, minerals, bioactive materials, pharmaceuticals, and the like, incorporated into the filler particles or structural matrix. The dry composites can make incorporated supplements more palatable and reduce gastric distress that can be associated with certain supplements. The structural matrix can include, e.g., reinforcement components, such as cellulose, starch, proteins with one or more hydrophilic region, modified or hydrolyzed starch, polyols, dry plant matter, minerals, grain flours, and/or the like.

The proteins in the structural matrix can be any functional and economical for the intended use. For example the matrix proteins can be whey proteins, bovine blood plasma proteins, gelatin, peanut proteins, cereal proteins, fish proteins, soy proteins, porcine blood proteins, pea proteins, rice proteins, wheat proteins, and/or the like. The proteins of the structural matrix can be are naturally cross-linked, e.g., without the use of glutaraldehyde, reducing sugars, or synthetic linkers.

The filler particles can include, e.g., lipids, such as one or more oils, fats, monoglycerides, diglycerides, triglycerides, free fatty acids, oleic acid, conjugated linoleic acid, linolenic acid, phytanic acid, omega 3 fatty acids, C22:6 fatty acids, eicospentaenoic acid (C20:5), corn oil, poppy seed oil, fish oil, cotton seed oil, soybean oil, walnut oil, safflower oil, sunflower oil, peanut oil, palm oil, marine lipids, sesame oil, canola oil, linseed oil, and/or the like. The filler particles can include supplemental constituents, such as, e.g., vitamins, proteins/amino acids, nutrients, polyunsaturated lipids, minerals, bioactive materials, and pharmaceuticals, for delivery to the digestive tract. In a preferred embodiment the filler particles range in average diameter from about 0.1 μm to about 100 μm.

Methods of preparing a rumen protected dry composite include, e.g., drying of a composite gel. For example, dry composites with an average particle size 150 μm or more can be prepared by drying composite gels before or after particle sizing. In one aspect of the invention, the method of preparing a rumen protected dry composite includes, e.g., dispersing a lipid filler composition into a matrix suspension to form a colloidal dispersion, spraying drops of the colloidal dispersion into or onto a gelation media or preparing a phase suspension of colloidal dispersion drops in a gelation media, heating the drops to produce composite gel particles, and drying the gel particles to form dry composite particles in which the lipid and/or matrix of the dry composite is protected against degradation, modification, or removal during passage through a rumen or stomach of an animal. Heating and/or drying steps can optionally avoid conditions conducive to the Maillard browning reaction, e.g., by avoiding excessive reducing sugars, using lower temperatures, and/or retaining some water in the product.

The composite gel and dry composites can incorporate a reinforcement component into the matrix, e.g., to provide stability to the matrix, reduce shrinkage on drying, reduce migration of filler particle lipids, provide caloric and/or nitrogen nutrients to the ruminant. Typical reinforcement components include, e.g., cellulose, starches, proteins, modified or hydrolyzed starches, polyols, dry plant matter, a mineral, grain flours, and the like.

Preparation of a colloidal dispersion from a blend of filler composition and matrix suspension can include, e.g., emulsification, suspension, and/or homogenization of the blend, e.g., to produce filler particles ranging in average diameter from about 0.1 to μm to about 100 μm. The filler particles of the lipid filler composition can include, e.g., one or more: oils, fats, monoglycerides, diglycerides, triglycerides, free fatty acids, oleic acid, conjugated linoleic acid, linolenic acid, phytanic acid, omega 3 fatty acids, C22:6 fatty acids, eicospentaenoic acid (C20:5), corn oil, poppy seed oil, fish oil, cotton seed oil, soybean oil, walnut oil, safflower oil, sunflower oil, sesame oil, canola oil, or linseed oil.

The colloid dispersion can be heated in a container, conduit, or other gelation media to form a composite gel. For example, the colloidal dispersion can be held for from about 0.5 hours to about 24 hours at a temperature ranging from about 4° C. to about 50° C., e.g., to allow preliminary association and cross linking of proteins at the filler particle surfaces and in the matrix. The colloid dispersion can be further heated to form the composite gel, e.g., by heating the dispersion to 80° C. to 150° C. (or more) for from about 10 minutes to about 250 minutes. The composite gel can be prepared in batches or in continuous flow processing. Heating can take place with the dispersion in a container, such as a metal can or plastic bag, e.g., with at least one dimension ranging from 1 mm to 0.5 m. The composite gels can also be formed, e.g., by heat treatment of drops formed by spraying dispersion onto or onto a gelation media. The composite gels can be formed by heat treatment of drops formed by preparing a phase suspension of the colloidal dispersion in a gelation media, such as an oil. The dispersion drops can be sprayed or collected onto a moving surface (such as, e.g., a heated conveyor belt or drum) or into a stirred vessel of heated gelation media to form composite gel particles. The gelation media can be an oil, such as, e.g., corn oil, that drains or is washed from the composite gel particles after gelation. Optionally, gelation media residue is allowed to remain on gel particle surfaces.

The size of composite gel or dry composite particles can be adjusted, e.g., by extruding, cutting, slicing, grinding, sonicating, or milling techniques. In preferred embodiments, the composite gel or dried composite particles have an average particle size of 150 μm or more, or range in size from about 0.001 mm to about 100 mm or more, or from about 1 mm to about 10 mm.

Composite gels can be dried to form dry composites. The gel can be dried, e.g., by oven drying, tunnel drying, continuous belt drying, microwave energy, fluidized bed drying, freeze drying, flash drying, and/or the like.

Methods of the invention further include feeding the dry composite to an animal, such as a cow, sheep, deer, elk, bison, goat, llama, horse, pig, chicken, fish, dog, or cat. The dry composition can be rehydrated before feeding to the animal. The dry composition can be fed to an animal, such as a ruminant before milking the animal to collect milk having a modified lipid composition, supplemental nutrients, or bioactive agents. The milk can be processed to prepare a dairy product, such as, e.g., butter, low-fat milk (i.e., milk with some, but not substantially all, of the milk fat removed, e.g., “2% milk”), dried milk, sour cream, cream, ice cream, cream cheese, cheese, yogurt, concentrated milk (condensed milk) and/or the like. Cream, included in the milk with modified fatty acids composition can be separated and utilized to produce anhydrous milk fat or fractions of anhydrous milk fat containing high levels of the desired unsaturated fatty acids. The dry composite can be fed to an animal, and the meat collected can have a modified fatty acid composition, supplemental nutrients, or beneficial bioactive agents.

The present invention includes systems to practice methods of the invention. Systems of the invention for preparing a rumen protected dry composite, can include, e.g., dispersion units containing the filler composition and the matrix suspension and functioning to suspend or emulsify the filler composition into the matrix suspension to form a colloid dispersion; heaters containing the colloid dispersion thus formed and functioning to convert the colloid dispersion into a composite gel; and, dryers containing the composite gel and functioning to remove water from the composite gel to form a dry composite protected against degradation, modification, or removal during passage through a rumen compartment or stomach of an animal. In another embodiment, the system is an automated system including, e.g.: a controller with access to dry composite process parameters; a dispersion unit in communication with the controller for suspending or emulsifying a filler composition into a matrix suspension to form a colloid dispersion; a heater in communication with the controller, and converting the colloid dispersion into a composite gel; and/or, a dryer in communication with the controller for removing water from the composite gel to form the protected dry composite.

Systems of the invention can produce the dry composites of the invention by, e.g., exposing process intermediates of the invention to conditions dictated by the compositions and methods parameters of the invention. Systems can provide, e.g., raw materials and process intermediates in proportions described herein. Systems can provide conditions of temperature, time, humidity, flow rates, pressure, energy, shear, and the like in accordance with process parameters described herein. Control of such parameters is facilitated by the use of a system controller. Process parameters commonly controlled in the systems include, e.g., filler to matrix proportions, emulsification pressures, filler particle sizes, gelation temperatures, gelation times, composite drying temperatures, composite drying times, dry composite residual moisture values, process intermediate transfers, and the like.

The dispersion unit of the invention can emulsify, suspend, and/or homogenize filler compositions into matrix suspensions to form colloid dispersions. Typical dispersion units include, e.g., high pressure homogenizers, sonicators, mixers, blenders, mills, fluidizers, and the like.

Colloid dispersions of the invention can be filled into containers for storage or heat treatment. Containers can be filled, e.g., using container filler equipment known in the art, such as, e.g., rotary can fillers, retorting sealers, baggers, and the like.

Colloid dispersions of the invention can be dripped or sprayed, e.g., to provide a desirable drop size for further processing. Systems of the invention can include sprayers such as atomizers, high pressure sprayers, sonicators, spinning disk slingers, BRACE process “shower heads”, and the like.

Colloid dispersions of the invention can be divided into drops, e.g., by phase suspension techniques. The phase suspension units, such as containers of agitated hydrophobic phase or static mixers, can break colloid dispersions into suspended drops. Provision of temperature control can allow phase suspension units to double as heaters in some embodiments of the invention.

Heaters of the systems can provide the temperature and time conditions required by gelation methods of the invention. Heaters can provide heat exchange surfaces (gelation media) appropriate to the particular embodiment of the invention. For example, the heaters can include gelation media, heated containers, heated oil, autoclaves, microwave energy, steam ovens, and the like.

Solid or semisolid process intermediates of the invention (such as gels and dry composites) can be size adjusted using a particle formation device. Particle formation devices of the invention can adjust the size of the composite gel or the dry composition, by breaking, crushing, extruding, cutting chopping, and the like. Particle formation devices can be, e.g., a masticator, a slicer, an extruder, a grinder, a blender, a food processor, and/or the like.

Dryers of the systems can reduce the water content of composite gels to form dry composites. Dryers can provide conditions of temperature, heat conductivity and humidity required by methods of the invention. Dryers can be configured to be well adapted to drying particular gel compositions and particle sizes. Typical dryers of the systems include, e.g., drying ovens, tunnel dryers, microwave ovens, continuous belt dryers, fluidized bed dryers, freeze dryers, flash dryers, drum dryers, and the like.

Systems to produce protected dry composites can beneficially include a controller. Controllers are typically digital logic devices, although certain mechanical and analog devices can provide useful controller functions. Controllers can communicate through I/O interfaces with one or more of the above listed system components, e.g., to automate system parameter controls, data acquisition, and quality control. In some embodiments, the controller is in communication with, e.g., the dispersion unit to control filler/matrix proportions, emulsification pressures, filler particle sizes, and the like; the heater to control gelation times and temperatures; and/or, the dryer to control drying times and temperatures, and/or the residual moisture of dry composite output.

### BRIEF DESCRIPTION OF THE DRAWINGS

FIG. 1 is an exemplary block flow diagram of a method and system functions for making a dried composite gel composition with particle formation from the composite gel before drying.

FIG. 2 is an exemplary block flow diagram of a method and system functions for making a dried composite gel composition with spraying or phase suspension of the colloid dispersion before heat treatment.

FIG. 3 is an exemplary block flow diagram of a method and system functions for making a dried composite gel composition with particle formation from the dry composite after drying of the composite gel.

FIG. 4 is a schematic diagram of a system for preparing protected dry composites.

FIG. 5 is a schematic diagram of an automated system for preparing protected dry composites.

### DEFINITIONS

Unless otherwise defined herein or below in the remainder of the specification, all technical and scientific terms used herein have meanings commonly understood by those of ordinary skill in the art to which the present invention belongs.

Before describing the present invention in detail, it is to be understood that this invention is not limited to particular methods or compositions. It is also to be understood that the terminology used herein is often used to describe particular embodiments not intended to limit the claimed invention.

As used in this specification and the appended claims, the singular forms “a”, “an” and “the” can include plural referents unless the content clearly dictates otherwise. Thus, for example, reference to “a component” can include a combination of two or more components; a reference to “containers” can include individual containers, and the like.

Although many methods and materials similar, modified, or equivalent to those described herein can be used in the practice of the present invention without undue experimentation, the preferred materials and methods are described herein. In describing and claiming the present invention, the following terminology will be used in accordance with the definitions set out below.

The term “dispersed phase”, as used herein, refers to a dispersion of lipid droplets or lipid particles (i.e., filler particles) protected within the continuous phase protein gel matrix of a composite gel. The filler composition of a colloidal dispersion can be substantially converted into the dispersed phase of a composite gel by heat treatment of the colloidal dispersion, and, ultimately, to the embedded filler particles in a dry composite, on drying of the gel.

The term “lipid”, as used herein, refers, e.g., to any oil, fat, or substantially hydrophobic organic material. “Filler particles” of the dry composite, and lipid droplets or lipid particles in the filler composition dispersed phase, can include, e.g., oils, fats, monoglycerides, diglycerides, triglycerides, free fatty acids; corn oil, poppy seed oil, fish oil, cotton seed oil, soybean oil, walnut oil, safflower oil, sunflower oil, sesame oil, canola oil, linseed oil; free, esterified, or conjugated: oleic acid, linoleic acid, linolenic acid, phytanic acid, omega 3 fatty acids, eicosapentaenoic acid; lipid-containing materials, such as whole or modified oil seed or beans (such as soybeans), grape seeds, cotton seeds, safflower seeds; algae, microorganisms, yeasts, protozoa, etc.; and/or the like.

The term “continuous phase”, as used herein, refers to the cross-linked protein gel matrix surrounding dispersed phase of filler particles in a composite gel of the invention. The matrix suspension of a colloidal dispersion can be substantially converted into the continuous phase of a composite gel by heat treatment, and to the structural matrix of a dry composite by drying of the gel.

The term “colloidal dispersion”, as used herein, refers to a mixture of lipid filler composition emulsified or suspended in a protein matrix suspension by the methods of the invention. Colloidal dispersions can include filler particles (e.g., lipid droplets and/or suspended solid particles comprising lipid). Colloidal dispersions of the invention can be converted into composite gels of the invention, e.g., by heat treatment.

The term “composite gel”, as used herein, refers to a continuous phase matrix of cross-linked proteins forming an aqueous gel surrounding a dispersed phase of lipid droplets or particles (i.e., filler particles).

The term “dry composite”, as used herein, refers to a composite of filler particles embedded in a structural matrix. Dry composites are “dry” in that, e.g., they can be prepared by drying a composite gel to some degree, e.g., 50% water removal or more. The structural matrix can be the composite gel continuous matrix after water has been removed to a desired degree of dryness. The structural matrix can include, e.g., matrix proteins and matrix reinforcement components. The dry composite can include, e.g., composite gels dried to contain about 25% residual moisture, about 15% residual moisture, about 12% residual moisture, about 10% residual moisture, about 8% residual moisture, about 5% residual moisture, about 2% residual moisture, or less. A protected dry composite is a dry composite that can substantially protect filler particles and/or supplemental constituents during transit through an animals upper digestive tract (mouth, esophagus, stomach, and/or rumen compartment) so that the constituents of the structural matrix and/or filler particles are delivered to the lower digestive tract (small and/or large intestines) without significant degradation, removal or modification. A rumen protected dry composite can be a dry composite with lipids or supplemental constituents in the filler particles or structural matrix substantially protected against degradation, removal or modification during transit through a rumen compartment.

The term “matrix reinforcement component”, as used herein, refers to matrix components that provide a means to reduce migration of lipids from filler particles into the structural matrix of a dry composite. Matrix reinforcement components can provide this function by residing within spaces between the cross-linked proteins of the structural matrix and presenting an enhanced hydrophilic barrier around filler particles. Typically, matrix reinforcement components are substantially hydrophilic filler molecules introduced between the cross-linked proteins of the structural matrix functioning to stabilize the location of hydrophobic filler particle constituents in a dry composite. Matrix reinforcement components can include, e.g., hydrophilic polymers or hydrophilic small molecules. For example, matrix reinforcement components can be: polymers with abundant ionizable, polar, or hydrogen bonding chemical groups; cellulose, starches, dry plant matter, hydrophilic proteins, grain flours, polyols, water soluble salts, minerals, and/or the like.

The term “supplemental constituents”, as used herein, refers to desirable constituents of a gel composite or dry composite that are protected in the composite through a rumen compartment or stomach of an animal to provide benefits to the animal or animal products. Supplemental constituents can be present in the filler particles and/or the structural matrix of the dry composite (or the continuous phase of a composite gel). Supplemental constituents are, e.g., components of composite gels and dry composites that have useful functions in the composites supplementary to the structural and protective aspects of the composites. However, certain supplemental constituents can have dual functions, such as, e.g., a lipid can be a major filler particle component and also function as a feed supplement for modification of ruminant milk fatty acid composition. Optionally, supplemental constituents are merely carried and protected by the filler particle and/or matrix structure of the gel or dry composite. Supplemental constituents can include, e.g., polyunsaturated fatty acids, monounsaturated fatty acids, free and esterified fatty acids, amino acids, proteins, pharmaceuticals, bioactive agents, nutrients, minerals, vitamins, antibiotics, and/or the like.

The term “effective amount”, as used herein, refers to an amount of specified material adequate to provide a desired effect. For example, an effective amount of a supplemental constituent in a composite gel can be an amount adequate to pass through the rumen to the post rumen digestive tract for provision of a desired effect. Desired effects can include, e.g., improved nutrition and health for the ruminant, pharmaceutical effects, effects on the composition of meat or milk, effects on the productivity of meat, eggs, milk, and/or the like.

The term “significant”, as used herein in the context of protected composites, methods of preparing dry composites and systems for preparing dry composites, means making a functionally significant contribution to, e.g., cross-linking of proteins in the composite (gel or dried composite) or a functionally significant improvement in protection of one or more composite constituents of interest during passage through a portion of a digestive tract (e.g., a rumen compartment or a stomach). For example, an amount of reducing sugar or aldehyde in a dispersion, gel or dry composite of the invention that provides a majority of cross-linking under conditions of heating or drying in methods of the invention as, compared to the same dispersion, gel or composition without the presence of the amount of reducing sugar or aldehyde is a significant amount of reducing sugar or aldehyde. Significant amounts of reducing sugars or aldehydes can be amounts that contribute more than 1%, more that 5%, more than 10%, or more than 25% to cross-linking of proteins in the dry composite. Significant amounts of reducing sugars or aldehydes can be amounts that increase dry composition protection of lipids or supplements through an upper digestive tract by a measurable and statistically significant amount, e.g., by 5%, by 10%, by 25%, or more, compared to the protection provided by the same dry composition without the presence of the reducing sugars or aldehydes during the preparation of the gel or dry composite. Amounts of aldehydes and/or reducing sugars in a matrix suspension, continuous phase matrix of a composite gel, or structural matrix that do not result in a functionally significant increase in cross-linking or protection of the final product are not considered significant amounts.

The term “substantially protected”, as used herein, refers to a significant protection of a gel or dry composite or of a composite component (e.g., matrix, filler particles, lipids and/or supplemental constituents) against degradation, modification and/or removal, as compared to the amount of degradation, modification and/or removal for the same component not protected in the gel or dry composite. For example, a component of a gel composite or dry composite can be considered protected if the component is significantly less degraded, modified or removed in a rumen compartment or stomach as compared to when the component is fed directly to an animal or when the component is fed as a component of an emulsion for preparation of the composite but before heat treatment.

### DETAILED DESCRIPTION

The present invention provides a dry composite, e.g., to protect lipids, proteins, nutrients, and/or supplemental constituents from removal, modification, and/or degradation during passage through the upper digestive tract of an animal. The invention provides methods and systems for making and using protected dry composites.

Briefly, the dry composites of the invention include, e.g., filler particles surrounded by a dried proteinaceous cross-linked structural matrix. The protective structural matrix may become rehydrated before or during ingestion but remains insoluble and substantially immune to attack by, e.g., microbes or proteases of the upper digestive tract during the time period of transit. The dry composite of the invention can then be dissolved or disassociated, e.g., on exposure to the conditions of a ruminant's abomasum or an animal's lower digestive tract.

The dry composite can be used to, e.g., increase availability of fatty acids in the abomasum and intestinal track of animals. Fats and/or oils can be incorporated into lipid particles or associated with hydrophobic environments of the dry composite structural matrix, where they do not come into contact with the microbes of the rumen or upper digestive tract secretions. The dry composites are palatable to the animals, do not cause gastric discomfort and can avoid toxic effects to rumen microbes. Substantial amounts of lipid can be delivered by dry composites to lower regions of the digestive tract where they can be absorbed into the blood stream and/or lymph circulation. The high caloric value of the delivered lipids can be especially beneficial to pregnant or nursing animals. The dry composites of the invention can enhance the productivity of farm animals, such as dairy cattle.

Polyunsaturated fatty acids protected in filler particles of a dry composite can avoid biohydrogenation by the microbes of the rumen. For example, when a polyunsaturated fatty acid, e.g., linoleic acid (C18:2), is fed to cattle, microbes of the rumen normally saturate both of the two carbon-carbon alkene double bonds by biohydrogenation to form stearic acid (C18:0). This saturation can be prevented by protecting the polyunsaturated fatty acid, or triglycerides containing the fatty acid, within the filler particles of a dry composite. After passing through the rumen into the abomasum, the structural matrix material can dissolve to release the filler particle lipids for absorption of the unmodified unsaturated fatty acids into the blood stream of the cow.

Once polyunsaturated fatty acids are in the blood stream of a cow, they can be captured by the mammary gland for incorporation into milk fat. Polyunsaturated fatty acids delivered by the dry composites of the invention, as described above, can thus provide milk and meat with a higher proportion of polyunsaturated fats. In addition to the human diet health benefits, food products with increased polyunsaturated fats can have desirable taste, texture, and/or rheological qualities. Polyunsaturated fats generally melt at a lower temperature than saturated fats so can influence the melting temperature of, e.g., cheese and ice-cream. Butter made with high polyunsaturated fat milk can have a smoother texture and can be more spreadable at storage temperatures.

In another aspect of the invention, the dry composites can protect proteins and amino acids as they pass through the upper digestive tract. Up to about 80% of unprotected amino acids or proteins fed to cattle are degraded by rumen microbes. The present invention includes a structural matrix with cross-linked proteins which are largely insoluble and resistant to degradation in the rumen. After passing to the abomasum, the cross-linked proteins can be dissolved and hydrolyzed to release unmodified amino acids for absorption in the lower digestive tract. The absorbed amino acids are then available for the production of meat and milk by the cow. The availability of unmodified amino acids is particularly important in the case of growing, pregnant or nursing cows.

The structural matrix can also provide, e.g., a protected environment to carry various hydrophilic and amphiphilic supplements through the upper digestive tract without degradation, modification, or removal. Water soluble vitamins such as, e.g., B vitamins and vitamin C can be remain as stable residue within the structural matrix of a dry composite. A ruminant's diet can be supplemented with essential amino acids, e.g., by adding them to the matrix suspension before gelation and drying of the continuous phase aqueous matrix to form a dry composite. Many water soluble hormones, pharmaceuticals, antibiotics and minerals can be delivered efficiently within hydrophilic environment of the structural matrix and matrix reinforcement components. By protecting supplements through the upper digestive tract, significant savings can be realized in the cost of administering nutrients and drugs to animals. The present invention can minimize the incidental exposure of microbes to antibiotics, thus reducing selection of antibiotic resistant bacterial strains.

The filler particles provide, e.g., protected lipid compartments to carry various hydrophobic and amphiphilic supplements through the upper digestive tract without degradation, modification, or removal. Fat soluble vitamins such as vitamin A, vitamin D and vitamin E can be delivered efficiently within the filler particles of a dry composite. Fat soluble hormones, sterols, pharmaceuticals, and antibiotics can be delivered efficiently within the filler particles of the dry composites. By protecting supplements through the upper digestive tract, significant savings can be realized in the cost of administering lipid soluble nutrients and drugs to animals.

THE DRY COMPOSITE

Dry composites of the invention can include, e.g., filler particles embedded within a structural matrix of cross-linked proteins. A colloidal dispersion of a lipid filler composition in a matrix suspension can be heated to form a gel of filler particles in a continuous phase matrix (a composite gel), and dried to form a dry composite of the invention. Although the undried composite gel generally has the protective benefits of its dry composite form described herein, the dry composite can provide additional benefits of, e.g., enhanced stability, enhanced protective characteristics, lighter weight, and more desirable mouth feel for some animals. A wide variety of supplements can be incorporated into a dry composite due to the broad range of applicable processing conditions and the availability of lipid and hydrophilic environments within the dry composite.

A dry composite structural matrix can include, e.g., a reinforcement component and protein scaffolding surrounding the embedded filler particles. The proteins of the structural matrix can be, e.g., naturally cross-linked by disulfide bonds, hydrophobic interactions, ionic interactions, hydrogen bonding, carbohydrates, and/or the like, to form a three dimensional network matrix structure containing the lipid phase filler particles. The matrix reinforcement component can provide, e.g., a hydrophilic bulk within the protein matrix, e.g., to reduce lipid migration and reduce matrix shrinkage when a gel is dried to form a dry composite. The dry composite structural matrix and filler particle constituents can be protected from removal, modification, and/or degradation in the rumen. During the emulsification stage of composite gel production, proteins can become adsorbed at the surface of the filler particles to form a layer of aggregated proteins coating each of the particles. The thickness of this layer can range, e.g., between about 50 nm and about 150 nm (nanometers). The protein layer adsorbed at the oil/water interface can be, e.g., a continuous monlayer or a multilayer, which can play a significant role in protection of the filler particles from oxygen and/or enzymes. The proportion of proteins engaged at the interface can be adjusted, e.g., during the emulsification and/or heating stages of the process associated with preparation of the composite gels. The layer of interfacially adsorbed proteins can become connected to a 3D protein matrix network, e.g., via protein-protein interactions, protein-reinforcement component interactions, and formation of other bonds.

The continuous phase of composite gels used to make dry composites can include water and various proportions of constituents in solution, suspension, or integrated in to the cross-linked protein matrix. Total solids of the matrix, determined, e.g., by weight on drying, can range from about 10% to about 50% of a dry composite gel weight. Conversely, a gel continuous phase can include from about 90% to about 50% water before drying to form a dry composite structural matrix. Proteins of a gel continuous phase can represent, e.g., from about 10% to about 100% of the total solids, from about 20% to about 50%, or about 35% of the continuous phase (and matrix) total solids by weight. Matrix reinforcement components can range from about 0% to about 90% of total solids in a matrix or gel continuous phase. Supplemental constituents can provide a substantial portion of the total solids in a gel continuous phase.

The dry composite structural matrix remains after drying of a composite gel continuous phase. The structural matrix can comprise, e.g., a protein matrix, matrix reinforcement component, supplemental constituents, and/or residual water. The protein matrix can represent from about 100% to about 5%, or from about 90% to about 25%, or from about 75% to about 50% of the structural matrix. The matrix reinforcement component can represent, e.g., from about 95% to about 0%, from about 10% to about 75%, or from about 25% to about 50% of the structural matrix. Supplemental constituents can represent, e.g., from about 50% to about 0% of the structural matrix. Water can represent, e.g., from about 25% to about 0%, about 10% to about 2% or about 5% of the structural matrix in a “dry” composite. In a preferred embodiment, the structural matrix includes about 20% protein, about 70% reinforcement component, and about 10% water.

Proteins of the dry structural matrix provide many useful characteristics to dry composites of the invention. The proteins can form, e.g., a continuous layer or network around filler particles, and/or a 3-dimensional matrix around filler particles, that reduces migration of the lipid, reduces contact of the lipids with destructive upper digestive tract enzymes, and/or reduces chemical degradation of the lipids, thus stabilizing the lipids through the upper digestive tract. The proteins can provide an animal with significant amounts of nutrient nitrogen in the form of amino acids, e.g., released in the lower digestive tract. The proteins can form a matrix (often in combination with reinforcement components) that facilitates handling of the composite and prevents coalescence of the filler particles. The proteins can provide resiliency to the structural matrix. Matrix proteins can be any available, economical and functional proteins, such as, e.g., whey proteins, bovine blood plasma proteins, gelatin, peanut proteins, cereal proteins, fish proteins, soy proteins, porcine blood proteins, pea proteins, rice proteins, wheat proteins, and/or the like.

The reinforcement component can provide multiple benefits to the dry structural matrix, such as, e.g., structural support, bulking, lipid confinement, and/or nutrition. The presence of a matrix reinforcement component can allow use of relatively hydrophobic proteins in the structural matrix without migration of filler lipids and collapse of the matrix structure. The bulk of reinforcing components can facilitate handling of the dry composite. The bulk of the reinforcing components can fill and/or structurally interact with the protein matrix to stabilize the matrix size and shape during and after drying. For example, the reinforcement components can significantly reduce shrinkage of the matrix during drying and/or prevent the dispersed filler particles from contacting or coalescing with each other compared to the same matrix without the reinforcement component. A structural matrix can include, e.g., 0% to 95% reinforcement constituents, from about 10% to about 90% reinforcement constituents, or from about 25% to 27% reinforcement constituents by weight. The reinforcement component can physically and/or chemically constrain filler particles. For example, certain reinforcement components can form glassy matrices having hydrophilic interfaces, e.g., supporting protein layers or networks around filler particles and repelling the lipids to prevent migration out of the filler particles. The reinforcement components can be generally recognized as safe feed ingredients. The reinforcement components can provide nutritional benefits, such as, e.g., acting as a carrier for supplemental constituents, and/or providing a carbohydrate energy source.

Useful reinforcement components can vary widely depending on, e.g., the nature of other dry composite components, availability, economics, ruminant type, required shelf life, and/or the like. Reinforcement components function to reduce migration of filler particle hydrophobic components by encasing them in a hydrophilic barrier. The reinforcement components can be crude, semi-purified, purified, natural, and/or synthetic materials. Preferably, the reinforcement component is an inexpensive plant product high in carbohydrate. Optionally, proteins, in addition to the matrix proteins surrounding the filler particles, can function as reinforcement components. Reinforcement components can include, for example, cellulose, starches, polyols, dry plant matter, grain flour, proteins (preferably hydrophilic proteins), and/or the like.

The colloidal dispersion continuous protein matrix can be formulated to include various supplemental constituents, e.g., water soluble or protein associated nutrients, amino acids, proteins, minerals, pharmaceuticals, bioactive molecules, vitamins, and/or the like, that ultimately remain as residuals in the structural matrix of the dry composite. Such supplements can be beneficially protected for efficient administration to animals. Mineral supplements, such as, e.g., sodium, calcium, magnesium, phosphate, and/or the like, can also influence the physical character of the dry composite. For example, the presence of divalent cations can alter the tensile strength, malleability, flexibility, compressive strength, ruggedness, and/or the like, of the dry composite structure.

Water in dry composites of the invention can play significant roles. For example, water can enhance the stability of matrix constituents by, e.g., providing water of hydration to proteins and bioactive agents, providing a stabilizing environment to some supplemental constituents, and/or reducing peak temperatures during processing. Water in the dry composite can carry soluble constituents, enhance the palatability of the composite, and/or provide desirable rheological characteristics to the composite. For dry composites intended for extended storage before consumption, it can be desirable to reduce the residual moisture to less than about 15%, less than 12%, less than 10%, less than 8%, less than 5%, less than 2%, or less than 1%. In some cases, it can be desirable to avoid very low residual moistures that can, e.g., excessively remove water of hydration and/or denature certain proteins, reinforcement components, and/or supplemental constituents of the dry composite.

The filler particles of the dry composite can be surrounded by the dry structural matrix. The lipids of the filler particles can be, e.g., oils, fats, monoglycerides, diglycerides, triglycerides, phospholipids, and/or free fatty acids. The filler particles can range in size, e.g., from about 0.05 μm to about 1 mm, 0.1 μm to about 50 μm, from about 0.1 μm to about 1 μm, or about 0.5 μm (although particulate filler particles, such as ground seeds can be larger). Filler particles can represent from about 1% to about 75%, or from about 5% to about 50%, or from about 10% to about 25% of the dry composite by weight.

The filler particles can be, e.g., nutritional supplements selected to deliver a high caloric content through the rumen, and/or provide an increased mono-or polyunsaturated fat content to the milk or meat of the ruminant animal. The filler particles can, e.g., include corn oil, or other oils, with 25% or more conjugated linoleic acid or linolenic acid for incorporation into ruminant milk and/or meat. Preferred oils for filler particles of the dry composites include, e.g., corn oil, poppy seed oil, fish oil, cotton seed oil, soybean oil, walnut oil, safflower oil, sunflower oil, sesame oil, canola oil, and linseed oil.

The filler particles of the dry composites can be formulated to include, e.g., various other supplemental constituents such as lipid soluble nutrients, pharmaceuticals, bioactive molecules, polyunsaturated lipids, and/or vitamins. Such supplements can be beneficially protected against conditions of an upper digestive tract in the dry composites for efficient administration to animals.

Methods of Preparing Protected Dry Composites

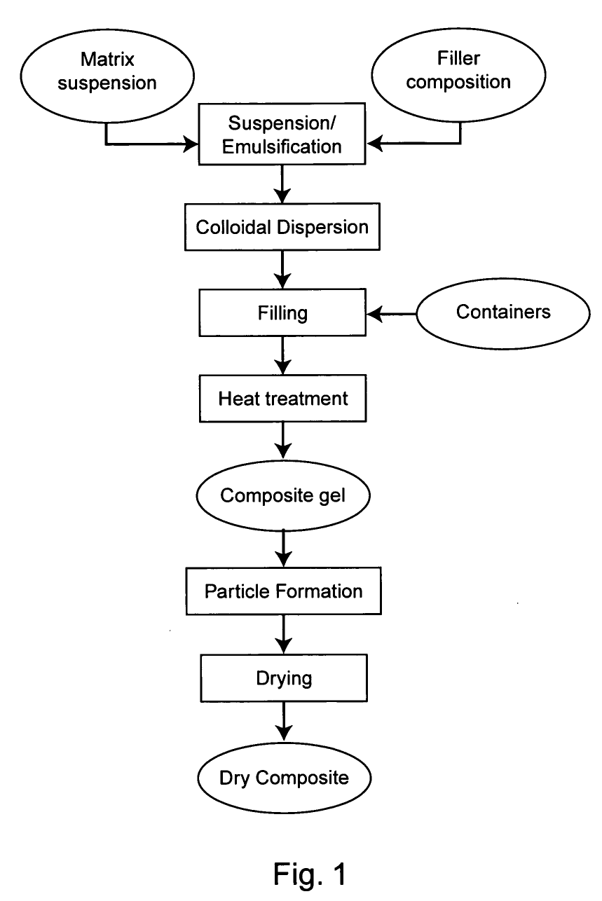

The dry composite of the invention can be prepared, e.g., by heating a colloidal dispersion to form a composite gel, and drying the gel to form the dry composite. For example, a dry composite can be prepared by: dissolving or dispersing protein, reinforcement components, and other constituents in water to form a solution or dispersion of a cross-linkable matrix suspension; preparing a filler composition of lipids and other filler particle components; emulsifying the filler composition into the matrix suspension to yield a colloidal dispersion with the filler phase dispersed in the matrix phase; filling the colloidal dispersion into containers, chambers or conduit; heating the colloidal dispersion to produce a composite gel comprising a dispersed phase of filler particles embedded in a continuous phase matrix of cross-linked proteins; breaking the gel into particles suitable for drying; and drying the gel to form a dry composite of filler particles embedded in a structural matrix, (see, FIG. 1).

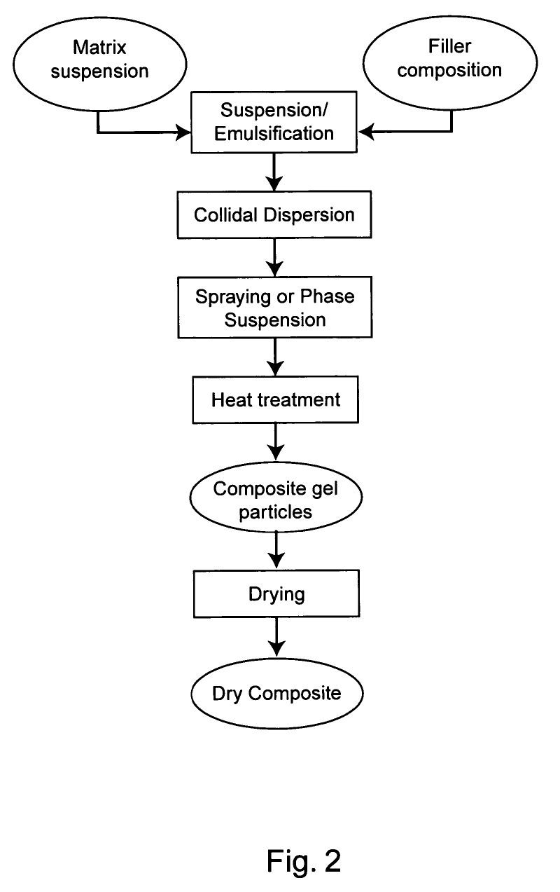

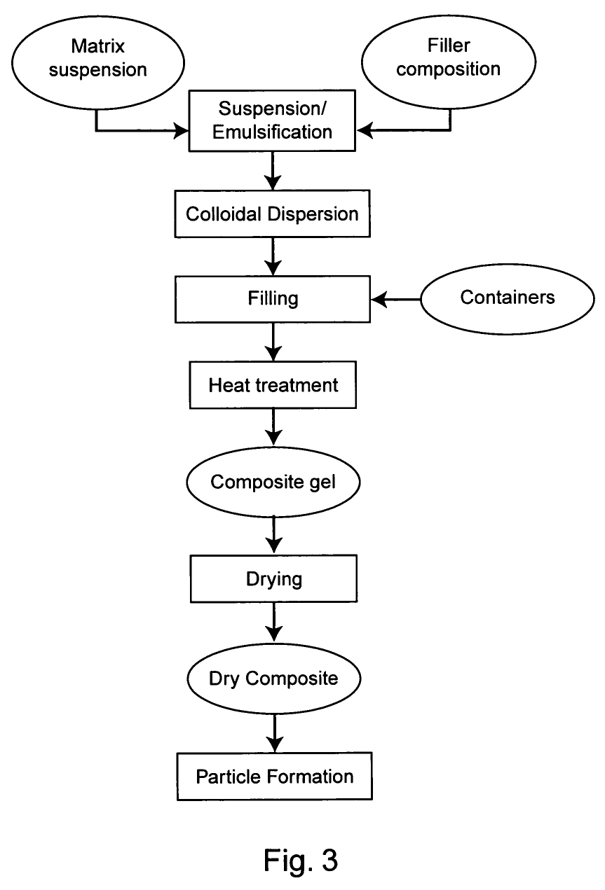

Dry composite for protection in passage through a rumen can be alternately prepared, e.g., by spraying the colloidal dispersion before heat treatment to form composite gel particles and drying the gel particles to form dry composite particles, as shown in FIG. 2. In another embodiment of the methods, dry composites can be prepared, e.g., by drying the composite gel before particle formation, as shown in the block flow diagram of FIG. 3. Other process alternates can be envisioned by those skilled in the art, based on this specification, e.g., wherein optional steps are added to the basic emulsification, gelation and drying steps.

The Matrix Suspension Phase of the Colloidal Dispersion

Formation of the covalent and/or non-covalent cross-links of the continuous matrix can be, e.g., a critical event determining the extent to which the dry composite protects the filler particles, and/or other included supplements, against digestion, modification, removal, and/or biohydrogenation in the upper digestive tract of animals. These natural cross-links can be formed: between protein molecules adsorbed at the oil/water (O/W) interface (i.e., the interface between the filler and the matrix phases); between protein molecules adsorbed at the O/W interface and protein molecules included in the matrix phase; between proteins and reinforcement components, and between protein molecules that are entirely in the matrix phase. Cross-linking of multiple protein molecules in 2 or 3 dimensions (e.g., at interfaces and/or throughout an aqueous phase) can provide a gel matrix.

Proteins suitable for use in the matrix of the invention can be, e.g., proteins that can be naturally cross-linked by heat treatment. For example, proteins that contain at least one cysteine residue can be cross-linked through the heat-induced unfolding to expose active sulfhydryl (SH) groups and, thereby promoting formation of covalent disulfide (S-S) bonds between protein molecules. Such disulfide bond cross-linking can be promoted, e.g., at temperatures of 80° C. or higher. The structural and textural properties as well as the porosity of the composite gel can be modulated by a combined influence of protein content, type of protein, heat treatment conditions, pH and minerals content of the matrix solution and/or dispersion.

Non-covalent attractions such as hydrophobic interactions, hydrogen bonding, ionic bonds, and/or the like, can provide cross-linking of matrix proteins. Heat can unfold proteins to induce cross-linking by non-covalent attractions. For example, heat can expose hydrophobic amino acids that were buried within globular proteins so they can interact with hydrophobic amino acids of near-by proteins to form elements of an aggregate or matrix structure, or so they can interact at interfaces with filler particles. In a similar fashion, heat can open protein structures to hydrophilic interactions, such as hydrogen bonding, with other proteins and/or matrix reinforcement components. In another example, heat can expose ionic amino acids of opposite charges for ionic interactions, or amino acids with the same charge to coordinate around an oppositely charged ion, such as, e.g., a divalent cation, to form a complex. In many embodiments of the invention, multiple types of interactions occur between proteins in the aqueous matrix suspension and/or at the interface with a filler particle to form cross-links of the continuous phase gel matrix.

Proteins can be also cross-linked through the Maillard reaction in the presence of reducing sugars. Although the temperatures and conditions commonly used in preparation of the aqueous composite gels of the invention (e.g., aqueous environments below 120° C.) can fail to significantly promote the Maillard reaction, it can contribute to cross-liking in some cases. The Maillard reaction can take place between the aldehyde group of a reducing sugar and the epsilon amino group of a lysine residue in a peptide chain. Reducing sugars that can act as reactants in the Maillard reaction include, e.g., glucose, lactose, fructose, mannose, maltose, ribose and galactose. Other reducing sugars and/or polysaccharides can be used in one aspect of matrix reinforcement to cross-link the proteins of the invention. In preferred embodiments of the invention, the emulsions are not exposed to conditions that result in significant Maillard cross linking and browning.

Exemplary proteins of the invention matrix include, but are not limited to, whey proteins, bovine blood plasma proteins, gelatin, peanut proteins, cereal proteins, fish proteins, soy proteins, porcine blood proteins, pea proteins, rice proteins, wheat proteins, and/or the like. Materials containing proteins that are suitable for utilization in preparing colloidal dispersions can be in the form of a solution or dispersion of these proteins, or in the form of dry powders containing such proteins. The protein-containing materials can include purified proteins, or can include proteins mixed with, e.g., different minerals, carbohydrates, and/or lipids. For example, whey protein materials can include, e.g., whey protein concentrates (WPC) containing between 30 and 90% protein, whey protein isolate (WPI) containing more than 90% protein, whey powders, demineralized or delactosed whey powders, fractionated, and modified whey proteins, etc. Such powders can contain a variety of minerals at different concentrations such as calcium, sodium, magnesium, potassium, phosphorous, etc. The protein-containing materials can also contain between 0% and about 70% carbohydrates (on dry basis), or more, that can act as convenient matrix reinforcement components. Materials containing whey proteins can originate as solutions or dispersions of proteins obtained during the common processing of liquid whey in the cheese industry. These commonly available materials can contain, e.g., between about 10% and about 60% protein (on dry basis) and can be concentrated by, e.g., membrane filtration operations, evaporation, centrifugation, spray drying, and/or the like.

To prepare a matrix suspension, a protein can be suspended or dissolved in water along with desired reinforcement components, and/or water-soluble supplemental constituents. The total solids of the matrix suspension can range, e.g., from about 10 percent to about 50 percent of the total weight. The proteins, in turn, can range, e.g., from about 10 percent to about 100 percent of the matrix suspension total solids by weight. Reducing sugars can be, e.g., about zero percent to about 50 percent of total solids by weight. Matrix reinforcement components in the matrix suspension can range from about 0% to about 90% of total solids.

Other matrix constituents, such as supplemental constituents, plasticizers, emulsifiers, stabilizers, anti-oxidants, redox-potential modifiers, minerals, texture modifiers, thickening agents, etc., can range, e.g., from about zero percent to about 20 percent or more of the total matrix suspension solids by weight. Such matrix components can be, but are not limited to, materials such as natural or modified gums that are permitted for utilization in feed and food preparations, starches, modified starches, dextrins, maltodextrins, etc. Some matrix components can function as reinforcement components. Supplemental constituents that can be added to the matrix suspension include, e.g., vitamins, nutrients, amino acids, peptides, minerals, hormones, bioactive materials, bioengineered compounds, pharmaceuticals, and/or the like.

Different strategies can be required to suspend or dissolve all matrix suspension components depending on the particular formulation. In some cases, a matrix mixture can require, e.g., agitating at temperatures ranging from about 10° C. to about 60° C. to obtain solution or suspension of ingredients. Depending on the formulation, a pre-suspension can be prepared with some components, such as difficult to dissolve components, followed by later addition of other components, such as less stable supplements. The pre-suspension can be warmed to the range of about 70° C. to about 95° C. for about 10 minutes to about 45 minutes to obtain a uniform suspension and/or to activate protein constituents. Then, the suspension can be cooled to between about 15° C. and 70° C. before adding the other, e.g., more soluble or less heat-stable components.

The pH of the matrix suspension components can be adjusted during or following suspension preparation to obtain a pH, e.g., between about pH 3 and pH 11, or between about pH 4 and about pH 8. Adept use of pH and temperature may be required to dissolve some proteins or supplemental constituents without degradation, as is known in the art. Depending, e.g., on the proteins used in the matrix suspension, pH can affect the amount of cross-linking and, ultimately, the porosity of the structural matrix. pH values of solutions can be adjusted with, e.g., feed grade acid or base, as appropriate. The pH of a matrix suspension can be adjusted to different values before heat treatment to influence the character of the gel or dry composite, as described above.

The Filler Composition

Filler particles suitable for use in the filler composition of the invention can be, e.g., lipids containing materials substantially insoluble in the matrix suspension and suitable for ingestion by an animal. The filler composition can be capable of emulsification with an aqueous matrix suspension for protective entrapment as the filler particles in composite gel and dry composite. The filler composition can contain, e.g., one or more desirable lipids and/or other supplements for protected passage through an upper digestive tract.

Exemplary lipids of the invention filler include, e.g., plant- or animal-derived oils, fats, fatty acids, monoglycerides, diglycerides, phospholipids, and/or triglycerides. Lipids can be in either the liquid state, in the solid state or optionally in association with plant matter or microbes. The filler composition lipid can include, e.g., blends of the aforementioned suitable lipids in various proportions, and can be a mixture of solid and/or liquid constituents. Lipids of the invention can beneficially include, e.g., free, esterified, or conjugated: oleic acid, linoleic acid, linolenic acid, phytanic acid, omega 3 fatty acids, eicosapentaenoic acid, and/or the like. Lipids-containing materials that can also be used in the filler composition include, e.g., whole or modified (e.g., broken) oil seed or beans (such as soybeans), grape seeds, cotton seeds, safflower seeds, and/or the like. Such materials can also include algae, microorganisms, yeasts, protozoa, etc., that contain desirable lipids or active constituents. Such lipid-containing materials can be whole, or modified by, e.g., crashing, grinding, breaking, flaking, heat-treating, and/or the like.

The range of other constituents, such as supplemental constituents and emulsifiers can be, e.g., from about zero percent to about 75 percent, or from about 10 percent to about 20 percent, of the total filler composition by weight. The filler particle lipid, itself can be considered a desirable supplemental constituent protected in the composite gel or dry composite. Supplemental constituents for inclusion in the filler composition can include, e.g., vitamins, nutrients, amino acids, peptides, proteins, microorganisms, polyunsaturated lipid constituents, hormones, bioactive materials, fatty acids, anti-oxidants, stabilizers, pharmaceuticals, and/or the like.

To prepare a filler composition, one or more lipids can be combined and mixed with desired supplements. Application of heat may be required to dissolve some lipids or supplements into the filler composition.

Emulsifiers can be added to either the matrix or the filler phase, or to both phases, to aid in the formation of a colloidal dispersion, e.g., during homogenization with the matrix. Emulsifiers can also aid in blending supplements into the colloidal dispersion. Emulsifiers can be either natural or synthetic surface-active compounds and materials that are, e.g., permitted to use in fed and food applications, as is known in the art.

Dispersion of Filler into Matrix

The physical character of the final dry composite, and the extent to which composite constituents are protected against digestion, modification, biohydrogenation, or removal in the upper digestive tract, can be significantly influenced by the particle size distribution of the filler phase. These properties can be determined, e.g., by the emulsification, suspension, and/or homogenization conditions used to combine the matrix suspension and filler composition. Those skilled in the art know to adjust, e.g., conditions of temperature, time, shear, pressure, matrix/filler proportions, additives, and/or the number of passes, to obtain a desired dispersed phase filler particle size without undue experimentation.

The first step in preparing a colloidal dispersion of the filler phase in the matrix phase can be, e.g., to prepare a coarse emulsion of the filler phase in the matrix phase. Such an emulsion can be made by using a bladed blender device or a high shear homogenizer equipped with an emulsification device. The emulsification can be carried out at temperatures ranging, e.g., between about 5° C. and about 65° C. for a period of time ranging from about 1 min to about 15 min. The mean particle size in this coarse emulsion can range, e.g., from about 5 μm to about 100 μm. The formation of the coarse emulsion can be facilitated by the presence of emulsifiers and/or feed grade surfactants in the formulation. The course emulsion can be processed as a colloidal dispersion directly into a composite gel or further homogenized. The course emulsion can provide, e.g., a uniform preparation for introduction into homogenizers typically used for form fine colloidal dispersions in methods of the invention. Colloidal dispersions can also be prepared by utilization of static mixers into which the colloidal dispersion of filler in matrix solution and an external dispersing medium are fed. Static mixers consist of a series of stationary element placed transversely in a tube. These elements form crossed channels that promote division and longitudinal recombination of the fluid flowing through the static mixer and, consequently, the dispersion/emulsification. An example is the Sulzer SMX static mixer (Sulzer Ltd, Zürcher Str. 12, CH-8401 Winterthur, Switzerland).

A fine colloidal dispersion can be prepared, e.g., from a course emulsion of the filler phase in the matrix phase. The coarse emulsion can be processed with a high pressure homogenizer, fluidizer, sonicator, and/or the like to prepare a fine emulsion. Common high volume equipment of this nature can achieve useful filler particle average diameters ranging from about 0.1 to μm to about 100 μm. Treatment of the coarse emulsion with a high pressure homogenizer at pressures ranging from about 5 MPa to about 75 MPa, or about 50 MPa, can yield filler particle sizes in the range from about 0.1 μm to about 10 μm. By passing the emulsion through the homogenizer one or more times, smaller and/or more uniform (e.g., unimodal) filler particle sizes can be achieved.

In one aspect of the invention, the filler particles have an average diameter of about 0.5 μm or less. Such a dispersed phase can have a specific surface area of more than about 10 m²/ml of filler phase, or about 15 m²/ml of filler phase. Without being held to a particular theory, significantly enhanced protection of the lipid phase from molecular oxygen and enzymes can be obtained by exclusionary effects of this large encapsulating surface area by highly cross-linked proteins.

Colloidal dispersions can be held at about 4° C. to about 50° C. for hold times ranging from about 0.5 hours to about 24 hours before proceeding to the heat treatment. Without being bound to a particular theory, it is believed that a hold time can allow proteins to become adsorbed at the lipid/aqueous interface, and allow time for some initial cross-linking interactions to begin. Alternately, the colloidal dispersion can often be heat treated immediately after homogenization with desired results.

In another aspect of the invention, colloidal dispersions of the lipids can be prepared and pre-heat treated, e.g., with less than all the continuous phase constituents. For example, a colloidal dispersion with less than all constituents can be pre-heat treated, at 70 to 90° C. for 10 to 45 minutes, e.g., to precondition the colloidal dispersion. Colloidal dispersions prepared in this way can then be used, e.g., to prepare the final colloidal dispersion for a final heat treatment to form a composite gel. After pre-heat treatment of colloidal dispersions, remaining continuous phase constituents can be added to the colloidal dispersion for dissolution, suspension, and/or dispersion. In other embodiments, protein solutions containing between 1% and 10% protein can be prepared, as described above, and pre-heat treated at about 70 to 90° C. for 10 to 45 min. The so treated solutions can be cooled, e.g., to a temperature from about 10° C. to about 50° C. and used to prepare the colloidal dispersion from which the composite gels can be prepared.

Spraying Colloidal Dispersions

Colloidal dispersions can be sprayed before heat treatment and gelation. Spraying can, e.g., form colloid dispersion drops with a high surface to volume ratio for rapid heating to gelation temperatures and substantially faster drying. Processes of dry composite production that include a spraying step can include, e.g., suspension and/or emulsification of a filler composition into a matrix suspension to form the colloidal dispersion, spraying to form drops, heat treatment of the drops to form composite gel particles, and drying to form dry composite particles, as shown in FIG. 2. Apparatus to spray colloidal dispersions can include, e.g., a reservoir of colloidal dispersion in fluid contact with a nozzle through a conduit. The colloidal suspension can be forced through the conduit and nozzle, e.g., by pressurizing the reservoir or using a pump in functional communication with the conduit. Colloidal dispersion sprayed from the nozzle can be heated, e.g., by contact with a gelation media to form composite gel particles. A colloidal dispersion can be sprayed after initial dispersion, after a holding period, or after a pre-heat treatment, e.g., as long as it retains a substantially sprayable fluid form.

Spraying of the colloidal dispersion is generally accomplished by passage of colloidal dispersion under pressure through a spray nozzle. Spraying can include methods known in the art, such as atomization, high pressure spraying, sonication, slinging from a spinning disk, vibrating nozzle spraying, and the like. In one embodiment the nozzle is a BRACE process “shower head” (BRACE GmbH Alzenau Taunusring 50, D-63755 Alzenau Germany). Finer drops of colloidal dispersion can generally be obtained, e.g., by spraying at higher pressures, by spraying at a lower flow rate, by spraying colloid suspensions with lower total solids, by spraying colloid suspensions containing surfactants, by spraying from nozzles with small diameter orifices, by breaking up a sprayed stream with atomizing gasses, by applying an electrostatic charge to the spray, and/or the like. Larger drops of colloidal dispersion can be obtained, e.g., by spraying at lower pressures, spraying with a higher colloidal suspension flow rate, spraying more viscous dispersions with higher total solids, spraying through a larger orifice, and/or the like. The size of sprayed colloidal dispersion drops can be adjusted, e.g., by adjustment of the factors cited above. In a preferred embodiment, the colloidal dispersion is sprayed from a nozzle at low pressure to form drops that essentially drip by gravity from the nozzle in volumes ranging from about 10 μL to about 200 μL, or from about 50 μL to about 100 μL, or about 25 μL.

It can be desirable to spray drops of colloid dispersion with average diameters ranging from about 0.01 mm to about 10 mm, from about 0.1 mm to about 1 mm, or from about 0.2 mm to about 0.5 mm. In a preferred embodiment, the average particle diameter is about 0.15 mm or more.

Spray drops or streams of colloidal dispersion can be received into gelation media, such as, e.g., heated fluid media including oils, hot humid gasses, fluidized beds, and the like. For example, the drops can fall into an oil bath heated to a desired gelation temperature. The oil can be agitated to suspend the drops as they are converted into composite gel particles. The gel particles can be harvested, e.g., by settling, sieving, and the like. Colloid dispersions, e.g., with short gelation times can be sprayed into a stream of high humidity heated gasses in which the drops can be converted to a gel state without substantial drying. This technique could be practiced, e.g., by capturing relatively small spray drops in a rising stream of hot gas to form a fluidized bed.

Spray drops of colloidal dispersion can be received onto gelation media, such as, e.g., continuous belts, high density fluids, rotating drums, and the like. The media surface can be in motion, e.g., as part of a continuous processing scheme in which spray drops are received at one end of the gelation media and composite gel particles are harvested at another end of the media. In many embodiments, the gelation media and spray drops are mutually repellant, e.g., due to electrostatic, ionic, and/or hydrophobic repulsion to facilitate harvesting of the composite gel particles.

Preparing Phase Suspensions

Colloidal dispersion drops can optionally be formed by phase suspension in which, e.g., the substantially aqueous phase dispersion is introduced into an agitated hydrophobic phase. For example, a colloidal dispersion batch can be poured into an agitated vat of vegetable oil to break the dispersion into drops of the desired size. Optionally, the hydrophobic phase temperature can be adjusted to provide hold temperatures, pre-heat treatment temperatures, and/or heat treatment temperatures to the drops.

The size of colloidal dispersion drops in the hydrophobic phase can generally be reduced by, e.g., higher agitation forces, the presence of surfactants in the dispersion or hydrophobic phase, higher temperatures, higher hydrophobic phase viscosities, introduction of the dispersion as a thin or fast stream or spray, and the like.

It can be desirable to prepare phase suspensions with colloid dispersion drops having average diameters ranging from about 0.01 mm to about 10 mm, from about 0.1 mm to about 1 mm, or from about 0.2 mm to about 0.5 mm. In a preferred embodiment, the average particle diameter is about 0.15 mm or more. In the case of static mixers, the design of the mixer can be adjusted to allow attaining desired particle size distribution of the dispersed particles. In such cases, geometry and number of flow regulating elements and the dimensions of the tube can be adjusted.

In one embodiment, a vat of vegetable oil at a holding temperature of 50° C. is agitated with an impeller while a 10% volume of colloid dispersion is poured into the oil. After several minutes, the average drop size is measured. If the drops remain larger than desired, the impeller speed is increased. After the holding period is completed, the temperature of the oil is increased to a heat treatment temperature, functionally converting the hydrophobic phase into a gelation media.

In another embodiment, the colloidal dispersion is continuously processed into drops in an agitated hydrophobic phase. In one aspect, colloidal dispersion can be fed into the hydrophobic phase through an immersed sieve with the size of drops initially determined by the size of holes in the sieve. In another aspect, the agitation vat can include a flow of hydrophobic phase through a screening mechanism that only allows passage of drops below a certain size dictated by the size of screen perforations. Drops passing through the screen can be further processed in the methods by, e.g., heating, collecting, washing, drying, and/or the like.

In many cases, drops prepared by phase suspension are separated from the hydrophobic phase material during later processing stages. Often, it is convenient to heat treat the drops to form composite gel particles to facilitate handling during removal of the hydrophobic phase. For example, drops can be heat treated to form gel particles before draining the hydrophobic phase, washing with a surfactant, or washing with an organic solvent to remove residual hydrophobic phase. In other embodiments, various amounts of residual hydrophobic phase can be acceptable or desirable and allowed to remain on the drops or gel particles.

Heat Treatment

Heat treatment can be used to cross-link proteins of the matrix suspension through the formation of cross-links consisting of covalent and/or non-covalent bonds, as described above in the Matrix Suspension section. These bonds can be formed as a result of protein-protein interactions, e.g., at the O/W interface, in the matrix phase, between proteins and reinforcement components, and/or between protein molecules adsorbed at the O/W interface and those protein molecules included in the matrix phase. Heat treatment can be used to cross-link proteins in the matrix phase through natural cross-linking, such as, e.g., disulfide bonding, hydrophobic interactions, and the like. Those skilled in the art can appreciate there are other ways to cross-link the proteins, e.g., pH treatments or addition of divalent linker molecules. However, heat treatment and natural cross-linking have certain advantages, such as, e.g., low cost and the absence of regulatory issues.

For heat treatment, the colloidal dispersion can be, e.g., filled into containers compatible with the heat, pressure, and chemistry of the treatment. For batch processes, the colloidal dispersion can be filled, e.g., into metal cans, glass bottles, or plastic containers of any suitable size. Containers can be sealed at atmospheric pressure, or at reduced pressure (vacuum sealing), to increase storage life, to prevent microbial contamination, and/or to reduce oxidative deterioration after the heat treatment. Those skilled in the art will appreciate that continuous processing schemes can be devised to heat treat colloidal dispersions, e.g., in a continuously flowing system of pipes or belts.

Heat treatments can be accomplished, without containers, by contacting the colloid dispersion with a gelation media. For example, as described above in the Spraying Colloidal Dispersions section, colloidal dispersions can be sprayed into or onto gelation media for heat treatment. In another aspect, gelation media can be a temperature controlled hydrophobic phase, as discussed in the Preparing Phase Separations section above. Heat treatments employing gelation media can follow time and temperature profiles similar to heat treatments in containers. However, in many embodiments of heat treating without a container, the colloidal dispersion surfaces exposed to the environment can be higher and considerations, such as humidity control, can be practiced to reduce any unwanted loss of water. Furthermore, in many embodiments of heat treatment without containers, the ratio of heated surface contact to colloidal dispersion volume is much higher, so that, e.g., temperature transitions occur faster and heating schedules can be shortened accordingly.

Heat treatment schedules can be established for compatibility with individual formulations and/or process efficiencies. Generally, a heat treatment to convert a colloidal dispersion of the invention into a composite gel requires heating the colloidal dispersion at, e.g., a temperature ranging from about 80° C. to about 250° C., or from about 90° C. to about 150° C., or to about 105° C., for a time ranging from about 10 minutes to about 250 minutes. Typically, conversion of a dispersion into a gel requires heating at a temperature ranging from about 80° C. to about 125° C. for a time ranging from about 20 minutes to about 180 minutes. Times and temperatures at the high end of these ranges can have the desirable effect of pasteurizing or sterilizing the composite gel, as is known in the art. Shorter times and temperatures can be used beneficially, e.g., with formulations containing easily cross-linked proteins or less stable supplements.

Heat treatment can provide cross-linking of matrix proteins through several mechanisms. Quaternary structure, tertiary structure and secondary structure of proteins can be disrupted by heat to expose chemical groups, such as amino acid side chains, that can interact to transform soluble proteins of the matrix suspension into the interconnected network of the continuous matrix gel. The proteins of the matrix can be, e.g., cross-linked by disulfide bonds, hydrophobic interactions, ionic interactions, hydrogen bonding, carbohydrates, and/or the like, to form a three dimensional network matrix structure containing the lipid phase.

Although Maillard reaction protein cross-linking by reducing sugars can play a role in methods of the invention, in many embodiments, it can be insignificant or nonexistent. In some embodiments, the presence of reducing sugars has been shown to actually reduce the protective effects of composite gels as compared to similar gels without reducing sugars. In other embodiments, although reducing sugars are present in some amount, they do not contribute significantly to cross-linking of the proteins due to, e.g., the overwhelming contributions of other bonds and interactions, the small amount of reducing sugars, and/or the reaction conditions of the methods fail to significantly promote the reaction. As the Maillard reaction releases water as a reaction product, the reaction can be inhibited by the aqueous conditions of gel formation in the method. In addition, the times and temperatures required to provide the other bonds or interactions described above are often inadequate to promote the Maillard reaction. Optionally, reducing sugars, and suitable heat treatment times and temperatures, can be provided to result in significant Maillard reaction protein cross-linking.

Following heat treatment, the composite gels of the invention can be immediately dried to form dry composites. Optionally, composite gels can be cooled to ambient temperatures, or colder, and held in storage as a process intermediate until initiation of the drying step. Optionally, composite gels described herein can provide protection through a rumen compartment or stomach of an animal without being dried. Storage life of a composite gel will depend on, e.g., the storage temperature, heat treatment time and temperatures, the storage container, the presence of antioxidant constituents, the presence of antimicrobial and/or anti-fungal constituents, and the stability of the composite protein or lipid.

Drying Composite Gels to Form Dry Composites

Drying of a composite gel into a dry composite can be by exposure of the gels to conditions of, e.g., raised temperature and low humidity for a time adequate to reduce the residual moisture to a desired level. The conditions and times can depend on a variety of factors, such as, e.g., the surface to volume ratio the gel, the starting percent water, the desired final percent water, temperature sensitivities of gel components and supplemental constituents, the porosity of gel surfaces and matrices, the presence of hydrophobic phase residue on the gel surface, the thermal conductivity of containers and gelation media, and the like. The presence of matrix reinforcement components can reduce shrinkage and filler particle migration as the gel dries into dry composite.

Drying can take place in appropriately designed equipment, such as, e.g., a drying oven, a tunnel dryer, a spray dryer, a microwave oven, a continuous belt dryer, a fluidized bed dryer, a freeze dryer, flash dryer, drum dryer, or the like. Where the gel has, e.g., a relatively low surface to volume ratio or where the gel contains temperature sensitive constituents, drying conditions can be enhanced by application of a vacuum. Moving belts or gelation media can be useful in drying schemes requiring continuous processing.

Drying of a composite gel to form a dry composite can take place, e.g., at temperatures ranging from about 35° C. or less, to about 250° C. or more, from about 50° C. to about 150° C., from about 70° C. to about 100° C., or about 90° C. Drying can continue for times ranging from less than about 10 minutes to about 2 days or more, about 0.5 hours to about 24 hours, or from about 2 hours to about 12 hours. For example, 2 cm thick composite gel cubes can be freeze dried at temperature ranging from about −10° C. to about 50° C. under a vacuum of less than 70 Torr for 24 hours (freeze drying can reduce the requirements for reinforcement components). In another example, 1 mm average diameter sprayed composite gel particles can be dried to desirable levels in an oven at 70° C. in about 3 hours.

Drying can be complete, e.g., when the dry composite retains half the amount of water as the original gel, or less. With gels having low total solids, it is generally desirable to reduce the water by 10-fold or more. Drying can be complete, e.g., when water in the gel has been reduced 1-fold, about 2-fold, about 4-fold, about 10-fold, about 25-fold, about 100-fold, or more. Drying can be complete, e.g., when residual moisture of the dry composite reaches a level of about 25% residual moisture (as measured e.g., by the Karl Fischer method), about 15%, about 10%, about 8%, about 5%, about 2%, about 1%, or less. In a typical embodiment, a composite gel, starting at 60% water by weight, is dried to a dry composite with a residual moisture value of about 10%.

In one embodiment, a composite gel is prepared in a container as a large block. The gel can be broken into smaller bits to increase the surface to volume ratio before drying. The gel can be removed from the container and reduced to an average particle size of about 1 inch cubed by, e.g., cutting, crushing, extruding, and/or the like. The gel cubes can be spread on trays and placed into an oven at about 95° C. for about 1 hour to remove at least half the water from the gel to form a dry composite.

In another embodiment, a colloidal dispersion with high total solids can be sprayed onto a conveyor belt gelation media moving into a steam oven at 95° C. for 10 to 45 minutes to form composite gel particles. The conveyor belt can continue on to a dry oven at 95° C. for 10 minutes to 5 hours for harvest of dry composite particles at the end of the belt.

In another embodiment, a colloidal dispersion can be poured into shallow metal trays and heat treated at 120° C. for 20 minutes in a pressurized steam oven (e.g., an autoclave) to form sheets of composite gel. The sheets can be placed in a dry oven at 80° C. over night to form sheets of dry composite. The dry sheets can be chopped into 1 cm sized pieces for storage in sealed containers before admixture into feed for ingestion by an animal.

In an exemplary method, a slab of composite gel was prepared to model a continuous processing system. An emulsion, consisting of WPI and soy oil, was heated to 60° C. and poured into an aluminum tray. The tray was covered with an aluminum foil and placed on a conveyor inside a steam tunnel. The steam tunnel was a commonly used steam blancher that is utilized by the fruit and vegetable industry. The steam was turned on to release live steam into the tunnel and after 30 min (in a steam saturated atmosphere) a slab of composite gel was easily released from the tray (by turning it upside down). This experience suggests, e.g., that an emulsion applied to a moving continuous belt through a steam oven can be heat treated to form a composite gel that will be easily released from the belt where it inverts at the end of the oven. Such a continuously produced gel can be, e.g., packaged and used as a protected gel or sliced into pieces for immediate drying on a drying oven belt to continuously produce protected dry composite.

Using Dry Composites

The dry composite of the invention can be fed directly to animals, such as ruminants, non-ruminants and pets. Alternately, the dry composites can be blended with more traditional feed, e.g., to provide stable, protected supplements to the feed.

The dry composites can be fed to domestic ruminants, such as cattle, goats and sheep, wild ruminants such as, bison, elk and deer, or to non-ruminants such as birds, fish, horses, pigs, and the like. Grazing animals and wild animals can be fed the invented composition, e.g., by including these supplements in feeding blocks or particulate/granular feed distributed for free access in grazing areas. Optionally, the dry composite can be a component of fodder, or mixed with fodder, provided in troughs for penned or feed lot animals. The dry composite can be formulated with particular proteins, lipids, and supplements suitable to provide a desired benefit to the animals.

The dry composites can be fed to domestic pets, e.g., to provide stable and efficiently delivered diet supplements. The dry composites can be mixed with the pet food, coated onto the pet food, and/or included as a constituent of pet food. The dry composite can be formulated to provide a smell, taste or texture desirable by particular pets. The dry composite can be rehydrated before feeding to provide a “gravy” or sauce component to the pet's food.

The dry composites of the invention can be packaged and stored for extended periods with or without refrigeration. Removal of water can result in some reduced volume, reduced packaging expense, and significant reduction in weight for easier handling from the point of manufacture, to storage, and feeding, over gel composites. Dry composites, e.g., with low residual moistures, aseptic handling, hermetically sealed containers, microbe inhibiting supplemental constituents, and the like, can be stored at ambient temperatures for days, weeks, or months. Dry composite can be packaged under a vacuum, at atmospheric pressure, in low or no oxygen modified atmosphere, in an inert gas atmosphere, or in any combination of gasses permitted in food and/or feed applications.

The dry composite can be fabricated, e.g., as granules sized from about 2 inches in diameter to 0.1 inches, from about 1 inch to about 0.25 inches, or less, for uniform mixing into ruminant or non-ruminant feed, such as, but not limited to, hay, seeds, silage, cereal grain or grain concentrate ingredients, alfalfa, pelletized feed, kibble, and the like.

In the case of a growing, pregnant, lactating, sick, or malnourished animal, a dry composite high in amino acids or peptides can be formulated for feeding. Amino acids, particularly essential amino acids or peptides containing essential amino acids, can be dissolved into the matrix suspension for incorporation and protection within the structural matrix the dry composite. The filler composition can receive certain amino acids, such as phenylalanine and tryptophan, or peptides containing them, for incorporation and protection within the filler particles of the dispersed phase. The cross-linked proteins of the structural matrix, and peptides that can be included in this phase, can be protected from conditions of upper digestive tracts to release significant amounts of supplemental of amino acids and peptides when hydrolyzed in the lower digestive tract.

Lipid in the filler particles of the dry composite can be formulated to supply high caloric value to feed and/or to provide desirable lipids that are polyunsaturated. The proportion of polyunsaturated fats in milk or meat can be increased and/or modulated in animals by feeding a dry composite formulated with lipids containing unsaturated (mono- and poly-) fatty acid constituents. An animal can be fed a dry composite in amounts wherein lipids represent, e.g., about 1% to about 25% of the total feed by weight. Rendered, recycled, or inexpensive low grade fats and oils can be formulated into the dry composite lipid for cost effective delivery of caloric value. Oils of plant or animal origin, such as, e.g., corn oil, poppy seed oil, cotton seed oil, soybean oil, walnut oil, canola oil, linseed oil, safflower oil, sunflower sesame oil, fish oil, and/or the like, can be used. Lipids in the dispersed phase filler particles can include, e.g., mono- di- or triglycerides containing desirable unsaturated fatty acids, free fatty acids, cholesterol esters, phospholipids, etc. Lipids-containing materials that can also be used as components of the filler composition include, e.g., whole or modified oil seed or beans (such as soybeans), grape seeds, cotton seeds, safflower seeds, and/or the like. Such materials can also include algae, microorganisms, yeasts, protozoa, etc., that contain desirable lipids or active constituents. Such lipid-containing materials can be whole, or modified by, e.g., crashing, grinding, breaking, flaking, heat-treating, and/or the like.

Dry composites can be used to efficiently deliver supplements to ruminant and non-ruminant animals. As discussed above in the Method of Preparing Protected Dry Composites section, supplements are a diverse group requiring consideration of issues, such as solubilities and stability of the supplement, for each formulation. In any case, supplements can be introduced into the gel preparation process, e.g., at or before the final heat treatment step whereby the colloidal dispersion is converted into a composite gel. If a supplement is particularly unstable, suitably mild time, temperature, and/or pH conditions can be established in later process steps to minimize degradation of the supplement. Formulations with unstable ingredients can also require cold storage or reduced storage times before feeding dry composites to animals.

After feeding the dry composite to an animal, the amino acids, lipids, and/or other supplements can pass through the upper digestive tract to appear in the lower digestive tract, for absorption into the blood stream, and/or the lymph system within minutes or hours. Polyunsaturated fats from dispersed phase filler particles can be observed in the milk fat of dry composite fed animals within hours. From the blood circulation and the lymph system, lipids or lipid constituents from dispersed phase filler particles can, e.g., be absorbed unmodified by fat cells in the animal's body for storage in lipid vacuoles associated with adipose tissue. Ultimately, lipids of the dry composite can appear in the fat cell marbling of the animal's meat (intramuscular lipid) as well as lipid covering the muscle. From the blood circulation and the lymph system, the delivered protected lipids or their constituents can become incorporated in the milk fat. From the blood circulation and from the lymph system, the delivered lipids or their constituents can be utilized by the natural mechanisms associated with animal physiology, disease regulation, immune system modulation, reproductive system aspects, etc.

In one embodiment of the invention, lipid biosynthesis can be modulated by provision of synthetic pathway constituents. For example, biosynthetic pathway reaction substrate molecules can be provided in the diet of a ruminant, protected through the rumen in the dry composite of the invention and enter cells of the ruminant to stimulate synthesis of reaction pathway products. In a particular embodiment, dry composites having oils rich in linolenic acid (C18:3) can be fed to cattle to stimulate a biosynthetic pathway providing increased production of fatty acids in the eicosanoic acid family. Increased amounts of eicosanoids can in turn support or stimulate pathways for production of certain bioactive molecules, such as, e.g., prostaglandins, thromboxanes, leukotrienes, lipoxins, and/or the like.

Other supplemental constituents in the dry composite structural matrix and/or filler particles can be carried in effective amounts through the upper digestive tract to provide benefits, e.g., in health, nutrition and productivity. For example, dry composites can be fed to ruminants to beneficially administer vitamins, nutrients, amino acids, peptides, proteins, microorganisms, polyunsaturated lipid constituents, carbohydrates, hormones, bioactive materials, fatty acids, anti-oxidants, pharmaceuticals, and/or the like. In one embodiment, vitamins can be economically administered to lactating cows without substantial losses in the rumen. In another embodiment, antibiotics can be administered, e.g., to fight a respiratory infection with reduced selective pressures on normal flora or pathogen microbes that could increase resistance.

Systems for Preparing Dry Composites

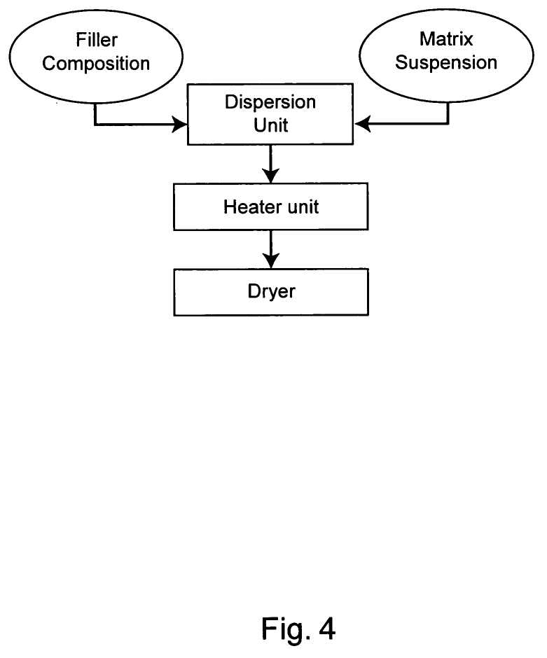

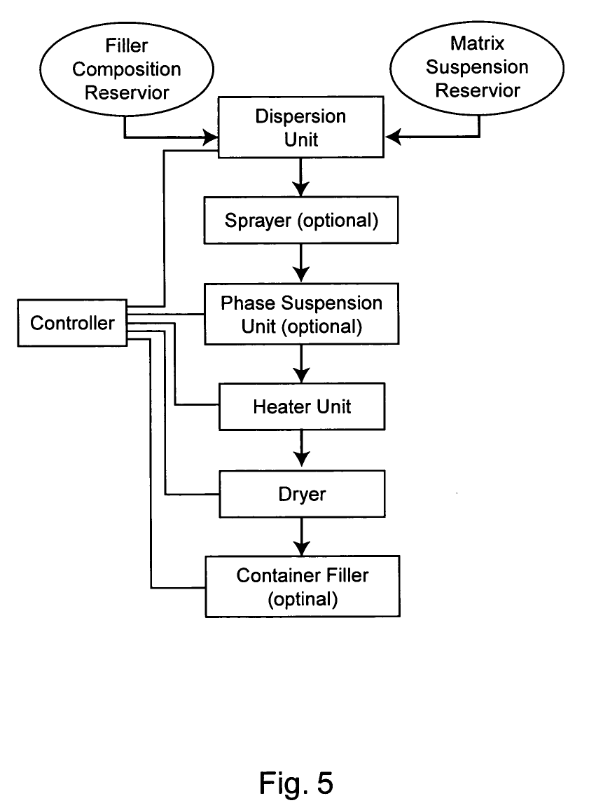

Dry composites can be manufactured using systems with components functioning to carry out process steps of the methods of the invention. Equipment can be provided to prepare matrix suspension (matrix) and-filler compositions (filler), suspend and/or emulsify the filler into the matrix to form a colloid dispersion, heat treat the dispersion to form a composite gel, and/or dry the gel to form a dry composite (see FIG. 4). Optional equipment can be provided to fill containers with dispersion before heat treatment, spray dispersions into drops, suspend dispersion into hydrophobic phases to form drops, and/or to break up gels or dry composites to form particles, as shown schematically in FIG. 5.

Equipment appropriate for preparing matrix suspensions and filler compositions can depend on factors, such as, e.g., the scale of the process lot, the requirements for heat, material transfer requirements, and/or the like. In general, equipment commonly available for the food or pharmaceutical industry are useful in preparing the filler and matrix. For example, stainless steel tanks with powered impellers, heaters, ports for introduction of ingredients, sensor ports for condition monitoring (pH, temperature, pressure, and the like), valves for sample removal, and/or the like, can be useful, particularly for large scale or highly regulated processes. Optionally, laboratory bench equipment, such as, e.g., glass beakers, mixers with magnetic stir bars, hot plates, and the like, can be adequate for production of small batches of filler and matrix.

Systems for preparing dry composites can include, e.g., a dispersion unit that functions to disperse (emulsify and/or suspend) the filler into the matrix. The dispersion unit can include batch processing equipment or continuous processing equipment. Filler can be coarsely dispersed into the matrix, e.g., by vigorously stirring, mixing, blending, or milling the two materials together in a vat. Coarse dispersions can be formed continuously, e.g., by flowing appropriate proportions together through conduit configured to provide appropriate shear or turbulence (e.g., in a static mixer) to break the filler into small enough droplets to remain dispersed until a following fine dispersion step. As filler particles in colloidal dispersions of the invention generally have an average diameter ranging between about 0.1 μm and about 100 μm, equipment, such as, e.g., high pressure homogenizers, sonicators, fluidizers, and the like, can be employed to disperse the filler into such small particles.

In processes where colloid dispersions are heat treated in containers, container fillers can be included in the system to efficiently fill the containers. In one embodiment, the container filler can be, e.g., a technician filling cans to a designated level by directing a flow of colloid dispersion pumped through a conduit from a vat. More sophisticated container fillers are well known in the food industry, such as, e.g., rotary fillers with multiple nozzles filling moving lines of cans as they rotate through the filler. Containers can be sealed manually, or, e.g., by the use of automated can sealers available in the food industry. For example, the containers can be retortable plastic cans or pouches with lids sealed by heat generated on spinning contact between the chamber and lid.

Sprayers of the systems can include, e.g., pressurized colloidal dispersion flowing through conduit to exit a spray nozzle as a spray of drops. The colloidal dispersion can flow from a pressurized chamber, or can be pumped from a chamber using a motorized pump. The nozzle can be, e.g., merely a constriction at the end of the conduit, or a sophisticated multifluid atomizing nozzle in which a stream of pressurized gas drives, disrupts, and/or directs the spray of dispersion drops. The spray nozzle can vibrate to affect, e.g., the size and/or uniformity of drops. A static charge can be applied to the spray drops to reduce coalescence in flight and/or on the gelation media. The sprayer is typically incorporated into a subsystem with other system components, such as, e.g., a phase separation unit or a heat treatment component.

A phase suspension unit of the system can be, e.g., a vat of agitated hydrophobic phase, or a continuous processing embodiment, e.g., wherein appropriate proportions of hydrophobic phase and colloid dispersion flow together through a conduit configured to provide shear or turbulence adequate to break the dispersion into drops of the desired size. Optionally the phase suspension unit can be a static mixer, as described above in the Emulsification/Homogenization section. Phase separation components can include heating elements for temperature control during optional holding, pre-heat treatment, and/or heat treatment functions in the unit. Phase separation units can include, e.g., sizing elements such as screens of sieves to selectively retain or remove drops of predetermined sizes.

The heater of the system can provide conditions to convert colloid dispersions into composite gels. For example, a heat treatment for gelation of a dispersion can require an environment of 80° C. to 150° C. for 10 minutes to 250 minutes. In cases where the dispersion is not protected from drying by sealing in a container or by immersion in a gelation media, the heater can include a substantially water saturated environment, such as those provided in a steam oven. Batch heat treatment processing is typically carried out in a closed or sealed oven. Continuous processing of dispersions into gels of the invention can be carried out, e.g., in flows of heated fluids, or on moving belts through open ovens. For example, gelation can be provided by passage of colloid dispersion through a microwave oven contained in a grid of plastic containers attached to a moving belt. Exemplary heaters include, e.g., heated gelation media, sealed containers, microwave ovens, heated oil, autoclaves, heated conduit, steam ovens, and the like.

A particle formation device of the system can be a device functioning to adjust the size of the composite gel or the dry composition. For example, gels or dry composites formed as blocks or sheets can be broken into particles of a desired size, e.g., to promote drying, or to facilitate handling and admixture with ruminant feed. A particle formation device can be, e.g., simply, a technician manipulating a knife, or passing the material through a framed wire or blade grid. Alternately, the particle formation device can be, e.g., a device, such as a masticator, a slicer, an extruder, a grinder, a blender, a food processor, and/or the like. The particle formation device can include a sizing element, such as a screen, to select or remove particles of a designated size.

Dryers of the system provide conditions to remove water from composite gels to form dry composites. Dryers can allow batch processing or continuous processing at a scale appropriate to the desired output. Appropriate dryers can include, e.g., drying ovens, tunnel dryers, microwave ovens, continuous belt dryers, fluidized bed dryers, freeze dryers, drum dryers, flash dryers, and the like. The dryers can be required to provide temperatures ranging from 35° C. or less, to about 250° C. or more. Dryers can provide temperatures typically ranging from about 50° C. to about 150° C., from about 70° C. to about 100° C., or about 90° C. Dryers can dehydrate gels for times ranging from less than about 10 minutes to about 2 days or more, about 0.5 hours to about 24 hours, or from about 2 hours to about 12 hours, depending, e.g., on the amount of water to be removed, the sensitivity of constituents to heat, and size of particles. In one embodiment, the dryer is a drying oven with racks for trays and providing a stream on temperature and humidity controlled drying gas across the trays. In another embodiment, the dryer is a tunnel dryer through which gel is continuously added at one end to tumble in a heated environment to exit the far end as a dry composite.

The systems of the invention can include one or more independent components, and/or two or more integrated components in a stand-alone system or subsystem. For example, a system for preparing a rumen protected dry composite can include a separate dispersion mixing vat, homogenizer, autoclave, extruder, and dryer. Optionally, the system can include subsystems incorporating, e.g.: a mixer, emulsifier, and sprayer; a sprayer, phase suspension unit, and heater; or a heater, particle formation device, and dryer. In one embodiment, a complete set of system components can be arranged into a fully integrated system including, e.g., a mixer feeding a coarse suspension of filler and matrix to a homogenizer, which provides dispersion to a sprayer that sprays drops onto a continuously moving gelation media, that transports composite gel to a belt dryer, which drops dry composite into a product receiver.

The systems of the invention can include, e.g., automated systems with controllers programmed with dry composite process parameters, and in communication with other system components to control one or more process step. An automated system for preparing a rumen protected dry composite can include, e.g., a digital controller in communication with: a dispersion unit, a container filler, a sprayer, a phase suspension unit, a heater, a particle formation device, and/or a dryer.

The controller can be, e.g., a digital computer in communication with other system components through an I/O interface. The computer can store process parameters, receive information from transducers (sensors) in the system components, evaluate conditions based on programmed process parameters, send instructions to actuators in the components to control process parameters, and/or store process data. Systems in the present invention can include, e.g., a digital computer with databases and instruction sets entered into a software system to practice the methods of preparing protected gels and dry composites, described herein. The computer can be, e.g., a PC (Intel x86 or Pentium chip- compatible with DOS®, OS2®, WINDOWS® operating systems) a MACINTOSH®, Power PC, or SUN® work station (compatible with a LINUX or UNIX operating system) or other commercially available computer which is known to one of skill. The computer can be, e.g., a simple logic device, such as an integrated circuit or processor with memory, integrated into the automated system. Software for data acquisition and process control is available, or can easily be constructed by one of skill using a standard programming language such as Visualbasic, Fortran, Basic, Java, or the like.

The dispersion unit can include, e.g., temperature sensors, pressure sensors, and turn counters that provide the controller with sensor signals; and/or with mechanical actuators that allow the computer to physically control process functions, such as fluid flows. The controller can evaluate sensor data and send instructions that keep process parameters within designated ranges. For example, the controller can receive sensor information indicating filler or matrix volumes, pressures, temperatures, flow rates, proportions, particle size, and the like. The controller can send appropriate commands to mechanical actuators, such as solenoid valves, pressure controllers, heaters, pumps, and the like, to make the process conform to process parameters, such as those described above in the Methods of Preparing Protected Dry Composites section.

As with the dispersion unit, the heater can include sensors and actuators in communication with the controller. The heater can be in communication with the controller to control process parameters such as the gelation temperature for conversion of dispersion into gel, the gelation time, and transfer of the composite gel to the next system component, such as, e.g., a heater.

The dryer can include sensors and actuators in communication with the controller to ensure conformance with programmed process parameters. For example, the controller can control the composite drying temperature, the composite drying time, dry composite final residual moisture, and/or the like.

The controller can be interfaced with other components to ensure conformance of the process parameters with desired values programmed into the controller software or memory. Controllable parameters include, for example, container filler volumes, sprayer pressures, sprayer volumes, phase suspension agitation speed, phase suspension temperatures, particle formation device average particle sizes, other parameters described herein, and/or the like.

It is understood that the examples and embodiments described herein are for illustrative purposes only and that various modifications or changes in light thereof will be suggested to persons skilled in the art and are to be included within the spirit and purview of this application and scope of the appended claims.

All publications, patents, and patent applications cited herein are hereby incorporated by reference in their entirety for all purposes.

1. A dry composite comprising:
a) a structural matrix comprising: one or more cross-linked proteins, and a matrix reinforcement component; and,
b) filler particles embedded in the structural matrix;
wherein the dry composite substantially protects the filler particles against degradation, modification, or removal during passage through an upper digestive tract of an animal.

2. The dry composite of claim 1, wherein the cross-linked proteins are naturally cross-linked.

3. The dry composite of claim 1, wherein the proteins are not significantly cross-linked by reducing sugars.

4. The dry composite of claim 1, wherein the filler particles comprise: one or more oils, fats, monoglycerides, diglycerides, triglycerides, free fatty acids, oleic acid, conjugated linoleic acid, linolenic acid, phytanic acid, omega 3 fatty acids, C22:6 fatty acids, eicospentaenoic acid (C20:5), corn oil, poppy seed oil, fish oil, cotton seed oil, peanut oil, palm oil, marine lipids, soybean oil, walnut oil, safflower oil, sunflower oil, sesame oil, canola oil or linseed oil.

5. The dry composite of claim 1, wherein the filler particles range in average diameter from about 0.1 to μm to about 100 μm.

6. The dry composite of claim 1, wherein the filler particles comprise from about 10 percent to about 75 percent of the dry composite by weight.

7. The dry composite of claim 1, wherein the proteins are selected from the group consisting of: whey proteins, bovine blood plasma proteins, gelatin, peanut proteins, cereal proteins, fish proteins, soy proteins, pea proteins, rice proteins, wheat proteins, and porcine blood proteins.

8. The dry composite of claim 1, wherein the filler particles or structural matrix further comprise supplemental constituents.

9. The dry composite of claim 8, wherein the supplemental constituents are selected from the group consisting of: vitamins, proteins, amino acids, nutrients, polyunsaturated lipids, minerals, bioactive materials, and pharmaceuticals.

10. The dry composite of claim 1, wherein the reinforcement component comprises: a cellulose, a starch, a hydrophilic protein, a modified or hydrolyzed starch, a polyol, dry plant matter, a mineral, or a grain flour.

11. The dry composite of claim 1, wherein the dry composite comprises an average particle size ranging from about 0.01 mm to about 10 mm.

12. A method of preparing a protected dry composite, the method comprising:
a) preparing a composite gel; and,
b) drying the composite gel to form a dry composite;
wherein the dry composite comprises an average particle size of 150 um or more and filler particles in the dry composite are protected from degradation, modification, or removal during passage through a rumen compartment or stomach of an animal.

13. The method of claim 12, wherein the composite gel comprises a reinforcement component.

14. The method of claim 12, wherein said preparing or said drying does not produce significant cross-linking due to a Maillard reaction with reducing sugars.

15. The method of claim 13, wherein the reinforcement component comprises: a cellulose, a starch, a hydrophilic protein, a modified or hydrolyzed starch, a polyol, dry plant matter, a mineral, or a grain flour.

16. The method of claim 12, wherein said preparing the composite gel comprises dispersing a filler composition into a matrix suspension to prepare a colloidal dispersion.

17. The method of claim 12, wherein the filler particles range in average diameter from about 0.1 to μm to about 100 μm.

18. The method of claim 16, further comprising holding the colloidal dispersion for about 0.5 hours to about 24 hours at a temperature ranging from about 4° C. to about 50° C.

19. The method of claim 16, further comprising heating the colloidal dispersion to form a composite gel.

20. The method of claim 19, wherein said heating to form a gel comprises a temperature ranging from about 80° C. to about 150° C. for about 10 minutes to about 250 minutes.

21. The method of claim 12, wherein said preparing the composite gel does not comprise addition of significant amounts of an aldehyde or significant amounts of reducing sugar.

22. The method of claim 12, wherein said drying occurs under conditions not conducive to significant amounts of Maillard browning.

23. The method of claim 19, wherein said preparing the composite gel comprises batch processing or continuous processing.

24. The method of claim 19, wherein said preparing the composite gel comprises heating the colloidal dispersion in a container having a dimension ranging from 1 mm to 0.5 m.

25. The method of claim 19, wherein said preparing the composite gel comprises spraying drops of the colloidal dispersion into or onto a gelation media.

26. The method of claim 19, wherein said preparing the composite gel comprises preparing a phase suspension of the colloidal dispersion in a gelation media.

27. The method of claim 19, wherein said preparing the composite gel comprises spraying drops or a stream of the colloidal dispersion onto a moving surface or into a stirred vessel.

28. The method of claim 27, wherein the moving surface comprises a heated conveyor belt or drum.

29. The method of claim 12, wherein the filler particles comprise one or more: supplemental constituents, oils, fats, monoglycerides, diglycerides, triglycerides, free fatty acids, oleic acid, conjugated linoleic acid, linolenic acid, phytanic acid, omega 3 fatty acids, C22:6 fatty acids, eicospentaenoic acid (C20:5), corn oil, poppy seed oil, fish oil, cotton seed oil, soybean oil, walnut oil, safflower oil, sunflower oil, sesame oil, canola oil, or linseed oil.

30. The method of claim 12, wherein said preparing a composite gel comprises emulsifying a lipid filler composition in a matrix suspension.

31. The method of claim 30, further comprising spraying the colloidal dispersion into or onto a gelation media.

32. The method of claim 12, further comprising adjusting a size of the composite gel or dry composite by: extruding, cutting, slicing, grinding, sonicating, or milling.

33. The method of claim 12, wherein the composite gel or dried composite comprises an average particle size ranging from about 0.001 mm to about 100 mm.

34. The method of claim 12, wherein said drying comprises: oven drying, tunnel drying, continuous belt drying, fluidized bed drying, drum drying, freeze drying, or flash drying.

35. The method of claim 12, further comprising:
feeding the dry composite to an animal.

36. The method of claim 35, wherein the animal is a member of the group consisting of: cows, sheep, deer, elk, bison, goats, llamas, horses, pigs, chickens, fish, dogs, and cats.

37. The method of claim 35, further comprising rehydrating the dry composite before said feeding.

38. The method of claim 35, further comprising milking the animal, thereby collecting milk comprising modified lipid composition, supplemental nutrients, or bioactive agents.

39. The method of claim 38, further comprising processing the milk to prepare a dairy product.

40. The method of claim 39, wherein the dairy product comprises: low-fat milk, a cheese, a yogurt, an ice cream, a dried milk, butter, sour cream, anhydrous milk fat, fractions of anhydrous milk fat or cream.

41. The method of claim 12, further comprising:
feeding the dry composite to an animal; and,
collecting meat from the animal;
wherein the composite gel comprises a supplemental constituent and whereby the meat comprises a modified fatty acid composition, supplemental nutrients, or bioactive agents.

42. A method of preparing a protected dry composite, the method comprising:
a) dispersing a lipid filler composition into a matrix suspension, thus preparing a colloidal dispersion;
b) spraying drops of the colloidal dispersion into or onto a gelation media, or preparing a phase suspension of colloidal dispersion drops in a gelation media;
c) heating the drops to produce composite gel particles; and,
d) drying the gel particles to form dry composite particles;
whereby the lipid in the dry composite is protected against degradation, modification, or removal during passage through a rumen compartment or a stomach of an animal.

43. The method of claim 42, wherein the lipid comprises: one or more supplemental constituents, one or more oils, fats, monoglycerides, diglycerides, triglycerides, free fatty acids, oleic acid, conjugated linoleic acid, linolenic acid, phytanic acid, omega 3 fatty acids, C22:6 fatty acids, eicospentaenoic acid (C20:5), corn oil, poppy seed oil, fish oil, cotton seed oil, soybean oil, walnut oil, safflower oil, sunflower oil, sesame oil, canola oil, linseed oil, whole or modified oil seeds, whole or modified beans, grape seeds, cotton seeds, safflower seeds, algae, microorganisms, yeasts or protozoa.

44. The method of claim 42, wherein the lipid filler composition comprises filler particles ranging in average diameter from about 0.1 to μm to about 100 μm.

45. The method of claim 42, wherein the matrix suspension comprises proteins selected from the group consisting of: whey proteins, bovine blood plasma proteins, gelatin, peanut proteins, cereal proteins, fish proteins, soy proteins, pea proteins, rice proteins, wheat proteins, and porcine blood proteins.

46. The method of claim 42, further comprising holding the colloidal dispersion from about 0.5 hours to about 24 hours at a temperature from about 4° C. to about 50° C.

47. The method of claim 42, wherein said heating to form a gel comprises a temperature ranging from about 50° C. to 150° C. for 10 minutes to 250 minutes.

48. The method of claim 42, wherein the gelation media comprises an oil.

49. The method of claim 42, further comprising washing or draining the gelation media from the gel particles.

50. The method of claim 42, wherein said heating or said drying do not comprise conditions conducive to significant Maillard browning in the gel or dry composite.

51. The method of claim 42, wherein the matrix suspension comprises a reinforcement component.

52. The method of claim 42, wherein the matrix suspension does not comprise significant amounts of a reducing sugar or significant amounts of an aldehyde.

53. The method of claim 51, wherein the reinforcement component comprises: a cellulose, a starch, a hydrophilic protein, a modified or hydrolyzed starch, a polyol, dry plant matter, a mineral, or a grain flour.

54. The method of claim 42, wherein said drying comprises: oven drying, tunnel drying, continuous belt drying, drum drying, fluidized bed drying, freeze drying, or flash drying.

55. The method of claim 42, wherein the composite gel or dried composite comprises an average particle size ranging from about 0.01 mm to about 100 mm.

56. The method of claim 42, wherein said dispersing, spraying, heating, or drying comprise: batch processing or continuous processing.

57. The method of claim 42, further comprising:
feeding the dry composite to an animal; and,
milking the animal;
wherein the dry composite comprises supplemental constituents, whereby milk collected comprises: modified lipid composition, supplemental nutrients, or bioactive agents.

58. The method of claim 57, further comprising processing the milk to prepare a dairy product.

59. The method of claim 58, wherein the dairy product comprises: low-fat milk, a cheese, a yogurt, an ice cream, a dried milk, butter, sour cream, anhydrous milk fat or cream.

60. The method of claim 42, further comprising:
feeding the dry composite to a ruminant or non-ruminant animal; and,
collecting meat from the animal comprising: modified lipid composition, supplemental nutrients, or bioactive agents.

61. A system for preparing a protected dry composite, the system comprising:
a) a dispersion unit which contains a filler composition and a matrix suspension, and capable of suspending or emulsifying the filler composition into the matrix suspension to form a colloid dispersion;
b) a heater which contains the colloid dispersion and converts the colloid dispersion into a composite gel by heating; and,
c) a dryer which contains the composite gel and removes water from the composite gel to form a dry composite protected against degradation, modification, or removal during passage through an upper digestive tract of an animal.

62. The system of claim 61, wherein the dispersion unit comprises: a high pressure homogenizer, a sonicator, a mixer, a blender, a mill, or a fluidizer.

63. The system of claim 61, further comprising a container filler that fills containers with the colloid dispersion.

64. The system of claim 61, further comprising a sprayer that sprays colloid dispersions into drops.

65. The system of claim 61, further comprising a phase suspension unit that agitates colloid dispersions into suspended drops.

66. The system of claim 61, wherein the heater comprises: a gelation media, a container, a heated oil, an autoclave, or a steam oven.

67. The system of claim 61, further comprising a particle formation device that can adjust the size of the composite gel or the dry composition.

68. The system of claim 61, wherein the dryer comprises: a drying oven, a tunnel dryer, a spray dryer, a continuous belt dryer, a fluidized bed dryer, a drum dryer, a freeze dryer, or flash dryer.

69. The system of claim 61, further comprising a controller in communication with:
the dispersion unit to control a proportion, a pressure, or a filler particle size;
the heater to control a gelation temperature, or a gelation time; or,
the dryer to control a drying temperature, a drying time, or a residual moisture.

70. An automated system for preparing a protected dry composite, the system comprising:
a) a controller comprising dry composite process parameters; and,
b) a dispersion unit in communication with the controller, and which suspends or emulsifies a filler composition into a matrix suspension to form a colloid dispersion;
c) a heater in communication with the controller, and which converts the colloid dispersion into a composite gel; or,
d) a dryer in communication with the controller, and which removes water from the composite gel to form a protected dry composite.

71. The system of claim 70, wherein the process parameters comprise: a filler to matrix proportion, an emulsification pressure, a filler particle size, a gelation temperature, a gelation time, a composite drying temperature, a composite drying time, or a dry composite residual moisture.
